(19) United States
(12) Patent Application Publication
(10) Pub. No.: US 2022/0169245 A1
(43) Pub. Date: Jun. 2, 2022

(54) INFORMATION PROCESSING APPARATUS, INFORMATION PROCESSING METHOD, COMPUTER PROGRAM, AND MOBILE BODY DEVICE

(71) Applicant: SONY GROUP CORPORATION, TOKYO (JP)

(72) Inventors: YUSUKE HIEIDA, TOKYO (JP); RYUTA SATOH, KANAGAWA (JP)

(21) Appl. No.: 17/593,478

(22) PCT Filed: Jan. 27, 2020
(86) PCT No.: PCT/JP2020/002769

§ 371 Date: Sep. 20, 2021

(30) Foreign Application Priority Data
Mar. 29, 2019 (JP) 2019-068382

(51) Int. Cl. B60W 30/095; G06V 10/22; G06T 7/20; G06V 20/70; G06T 7/11; G06T 7/50; G06V 20/58; G08G 1/16

(52) U.S. Cl. CPC B60W 30/0956; B60W 2554/4041; G06T 7/20; G06V 20/70; G06T 7/11; G06T 7/50; G06V 20/58; G08G 1/16; G06T 2207/20021; G06T 2207/30241; G06T 2207/30261; B60W 2420/42; B60W 2556/10; B60W 2554/4029; B60W 2554/4026; G06V 10/22

(57) ABSTRACT

A moving range of an object is estimated on the basis of image information. An information processing apparatus includes an input unit that inputs an image, a region estimation unit that estimates a region of an object contained in the image, a moving history information acquisition unit that acquires information associated with a moving history of the object, a contact region determination unit that determines a contact region in contact with the object on the basis of an estimation result obtained by the region estimation unit, and a moving range estimation unit that estimates a moving range of the object on the basis of the moving history containing the contact region of the object. The moving range estimation unit estimates the moving range of the object on the basis of the moving history containing the contact region of the object and a moving track of the object.

### TECHNICAL FIELD

A technology disclosed in the present description relates to an information processing apparatus, an information processing method, a computer program, and a mobile body device for processing sensor information mainly received from an in-vehicle sensor.

### BACKGROUND ART

For achieving autonomous driving and ADAS (Advanced Driver Assistance System), a damage reduction brake function which senses an obstacle and prepares for a collision with the obstacle is essential for an automobile. Specifically, information obtained by an in-vehicle sensor such as a radar and a camera is analyzed using a computer, and then warning is given to a driver, or an auxiliary operation or an autonomous operation of a brake is performed. For example, a pedestrian running from a sidewalk to a driveway corresponds to an obstacle as a detection target. Moreover, running out of a bicycle needs to be detected.

For example, a prediction system having a following configuration has been proposed. Acquisition means acquires a learning result learned using a mobile body database which stores, for each of plural mobile bodies, space-time track data indicating a space-time track which associates a moving route position indicating a position of a moving route of previous movement of a mobile body with a time at which the mobile body is present at the moving route position, and mobile body attribute data indicating an attribute of the mobile body. In a case where a time and a space indicating a time and a position are designated, the designated space and time are defined as designated space and time, and prediction means predicts a possibility of appearance of the mobile body in the designated space and time on the basis of the leaning result acquired by the acquisition means (see PTL 1).

Moreover, there has been proposed a drive assist control device which includes pedestrian-or-others detection means for detecting a pedestrian or others moving on a roadside in a traveling direction of a vehicle, driving operation detection means for detecting a driving operation by a driver, and autonomous steering control means for executing autonomous steering control of the vehicle in a direction away from the pedestrian or others on the basis of detection of the pedestrian or others using the pedestrian-or-others detection means. The autonomous steering control means starts the autonomous steering control with reference to the driving operation by the driver after detection of the pedestrian or others using the pedestrian-or-others detection means to execute steering of the vehicle on the basis of prediction of a potential risk that the pedestrian or others found on the roadside during traveling of the vehicle will cross the road (see PTL 2).

Furthermore, there has been proposed a travel assist device that determines which of regions, the regions including a first driveway region corresponding to a traveling lane where an own vehicle is traveling, a second driveway region corresponding to a traveling lane where the own vehicle is not traveling, and a sidewalk region corresponding to a sidewalk, an object is located, and sets at least either an avoidance start condition or a moving range of the object predicted at the time of prediction of a future position of the object such that achievement of the avoidance start condition is more easily predicted in a case where the object is located in the first driveway region than in a case where the object is located in the second driveway region, and that achievement of the avoidance start condition is more easily predicted in the case where the object is located in the second driveway region than in a case where the object is located in the sidewalk region (see PTL 3).

### CITATION LIST

### Patent Literature

### [PTL 1]

JP 2013-196601 A

### [PTL 2]

JP 2017-206040 A

### [PTL 3]

JP 2018-12360 A

### SUMMARY

### Technical Problem

An object of the technology disclosed in the present description is to provide an information processing apparatus, an information processing method, a computer program, and a mobile body device for predicting a collision between a mobile body and an object on the basis of image information obtained by an in-vehicle camera or the like.

### Solution to Problem

A first aspect of the technology disclosed in the present description is directed to an information processing apparatus including an input unit that inputs an image, a region estimation unit that estimates a region of an object contained in the image, a moving history information acquisition unit that acquires information associated with a moving history of the object, a contact region determination unit that determines a contact region in contact with the object on the basis of an estimation result obtained by the region estimation unit, and a moving range estimation unit that estimates a moving range of the object on the basis of the moving history containing the contact region of the object.

The region estimation unit estimates the object on the basis of the image by using semantic segmentation. In addition, the contact region estimation unit estimates semantics of the region in ground contact with the object by using semantic segmentation.

The information processing apparatus according to the first aspect further includes a moving track storage unit that stores a moving track obtained by tracking the object. The moving range estimation unit estimates the moving range of the object on the basis of the moving history further containing the moving track of the object.

Moreover, the information processing apparatus according to the first aspect may further include a moving track prediction unit that predicts a future moving track of the object on the basis of moving track information associated with the object, and a contact region prediction unit that predicts a future contact region of the object on the basis of the moving history of the object, the time-series information associated with the contact region of the object, and prediction of the future moving track. In addition, the moving range estimation unit may estimate the moving range of the object further on the basis of the predicted future moving track and the predicted future contact region of the object.

Further, the information processing apparatus according to the first aspect may further include a target region estimation unit that estimates a target region corresponding to a movement target of the object on the basis of the future moving track of the object predicted by the moving track prediction unit, and a moving range re-estimation unit that re-estimates the moving range of the object estimated by the multi-moving range estimation unit.

Besides, the information processing apparatus according to the first aspect may further include a three-dimensional region information estimation unit that estimates three-dimensional region information associated with the object. In addition, the contact region determination unit may determine the contact region in contact with the object further on the basis of the three-dimensional region information.

Moreover, a second aspect of the technology disclosed in the present description is directed to an information processing method including an input step of inputting an image, a region estimation step of estimating a region of an object contained in the image, a moving history information acquisition step of acquiring information associated with a moving history of the object, and a moving range estimation step of estimating a moving range of the object on the basis of the moving history.

Further, a third aspect of the technology disclosed in the present description is directed to a computer program written in a computer-readable manner to cause a computer to function as an input unit that inputs an image, a region estimation unit that estimates a region of an object contained in the image, a moving history information acquisition unit that acquires information associated with a moving history of the object, a contact region determination unit that determines a contact region in contact with the object on the basis of an estimation result obtained by the region estimation unit, and a moving range estimation unit that estimates a moving range of the object on the basis of the moving history containing the contact region of the object.

The computer program according to the third aspect defines a computer program described in a computer-readable manner so as to achieve predetermined processing on the computer. In other words, a cooperative operation is implemented on the computer under the computer program according to the third aspect installed in the computer. In this manner, advantageous effects similar to those of the information processing apparatus of the first aspect are achievable.

Moreover, a fourth aspect of the technology disclosed in the present description is directed to a mobile body device including a mobile main body, a camera mounted on the mobile body or a camera that images surroundings of the mobile body, a region estimation unit that estimates a region of an object contained in an image captured by the camera, a moving history information acquisition unit that acquires information associated with a moving history of the object, a moving range estimation unit that estimates a moving range of the object on the basis of the moving history, and a control unit that controls driving of the mobile main body on the basis of the moving range of the object.

The control unit determines a danger level of a collision between the mobile main body and the object on the basis of a result of comparison between a predicted future reaching range of the mobile main body and the moving range of the object. In addition, the control unit controls driving of the mobile body to avoid the collision.

### Advantageous Effects of Invention

Providable according to the technology disclosed in the present description are an information processing apparatus, an information processing method, a computer program, and a mobile body device for predicting a collision between a mobile body and an object on the basis of region information obtained by semantic segmentation.

Note that advantageous effects described in the present description are presented only by way of example. Advantageous effects offered by the technology disclosed in the present description are not limited to those. Moreover, the technology disclosed in the present description further produces additional advantageous effects as well as the above advantageous effects in some cases.

Further objects, features, and advantages of the technology disclosed in the present description will become apparent in the light of more detailed description based on embodiments described below and accompanying drawings.

### BRIEF DESCRIPTION OF DRAWINGS

FIG. 1 is a block diagram depicting a schematic functional configuration example of a vehicle control system 100.

FIG. 2 is a diagram depicting a functional configuration example of an information processing system 200 (first embodiment).

FIG. 3 is a diagram depicting an example of an estimation result of an image region.

FIG. 4 is a diagram depicting an image of a contact region of a pedestrian A cut from the regional image depicted in FIG. 3.

FIG. 5 is a diagram depicting an example of history information associated with a ground contact surface of the pedestrian A.

FIG. 6 is a diagram depicting an example of an estimated moving range of the pedestrian A.

FIG. 7 is a flowchart presenting a processing procedure performed by the information processing system 200.

FIG. 8 is a diagram depicting a functional configuration example of an information processing system 800 (second embodiment).

FIG. 9 is a diagram depicting a moving track and a contact region predicted for the pedestrian A in the regional image.

FIG. 10 is a diagram depicting an example of history information and prediction information associated with a ground contact surface of the pedestrian A.

FIG. 11 is a diagram depicting an example of an estimated moving range of the pedestrian A.

FIG. 12 is a diagram depicting an example of an estimation result of an image region (a map projected in a bird's eye view direction).

FIG. 13 is a diagram depicting an example of history information and prediction information associated with a ground contact surface of the pedestrian A for the bird's eye view map depicted in FIG. 12.

FIG. 14 is a diagram depicting an example of history information and prediction information associated with a ground contact surface of the pedestrian A.

FIG. 15 is a diagram depicting moving easiness set for each contact region.

FIG. 16 is a diagram depicting an example of an estimated moving range of the pedestrian A.

FIG. 17 is a diagram depicting an example of an estimation result of an image region (a map projected in a bird's eye view direction).

FIG. 18 is a diagram depicting an example of history information and prediction information associated with a ground contact surface of the pedestrian A for the bird's eye view map depicted in FIG. 17.

FIG. 19 is a diagram depicting an example of history information and prediction information associated with a ground contact surface of the pedestrian A.

FIG. 20 is a diagram depicting an example of a moving range estimated on the basis of the history information and the prediction information associated with the ground contact surface of the pedestrian A and depicted in FIG. 19.

FIG. 21 is a diagram depicting an example of history information and prediction information associated with a ground contact surface of the pedestrian A.

FIG. 22 is a diagram depicting an example of history information and prediction information associated with a ground contact surface of the pedestrian A.

FIG. 23 is a diagram depicting an example of a moving range estimated on the basis of the history information and the prediction information associated with the ground contact surface of the pedestrian A and depicted in FIG. 22.

FIG. 24 is a flowchart presenting a processing procedure performed by the information processing system 800.

FIG. 25 is a diagram depicting a functional configuration example of an information processing system 2500 (third embodiment).

FIG. 26 is a diagram depicting an example of an estimation result of an image region (a map projected in a bird's eye view direction) together with a predicted moving track of the pedestrian A.

FIG. 27 is a diagram depicting an example of a redesigning result of a moving route of the pedestrian A on the basis of a target region.

FIG. 28 is a diagram depicting a re-estimation result of a moving range on the basis of the redesigned moving route of the pedestrian A.

FIG. 29 is a diagram depicting an example of an input image.

FIG. 30 is a diagram depicting an example of a result of prediction of a future moving track and a future contact region of a bicycle A in the input image depicted in FIG. 29.

FIG. 31 is a diagram depicting an example of history information and prediction information associated with a ground contact surface of the bicycle A.

FIG. 32 is a diagram depicting an example of an estimation result of an image region (a map projected in a bird's eye view direction) together with prediction of a moving track and a contact region of the bicycle A.

FIG. 33 is a diagram depicting an example of a redesigning result of a moving route of the bicycle A on the basis of a target region.

FIG. 34 is a diagram depicting an example of a re-estimation result of a moving range of the bicycle A re-estimated on the basis of the redesigned moving route.

FIG. 35 is a flowchart presenting a processing procedure (first half) performed by the information processing system 2500.

FIG. 36 is a flowchart presenting a processing procedure (second half) performed by the information processing system 2500.

FIG. 37 is a diagram depicting a functional configuration example of an information processing system 3700 (fourth embodiment).

FIG. 38 is a flowchart presenting a processing procedure performed by the information processing system 3700.

### DESCRIPTION OF EMBODIMENTS

Embodiments of the technology disclosed in the present description will be hereinafter described in detail with reference to the drawings.

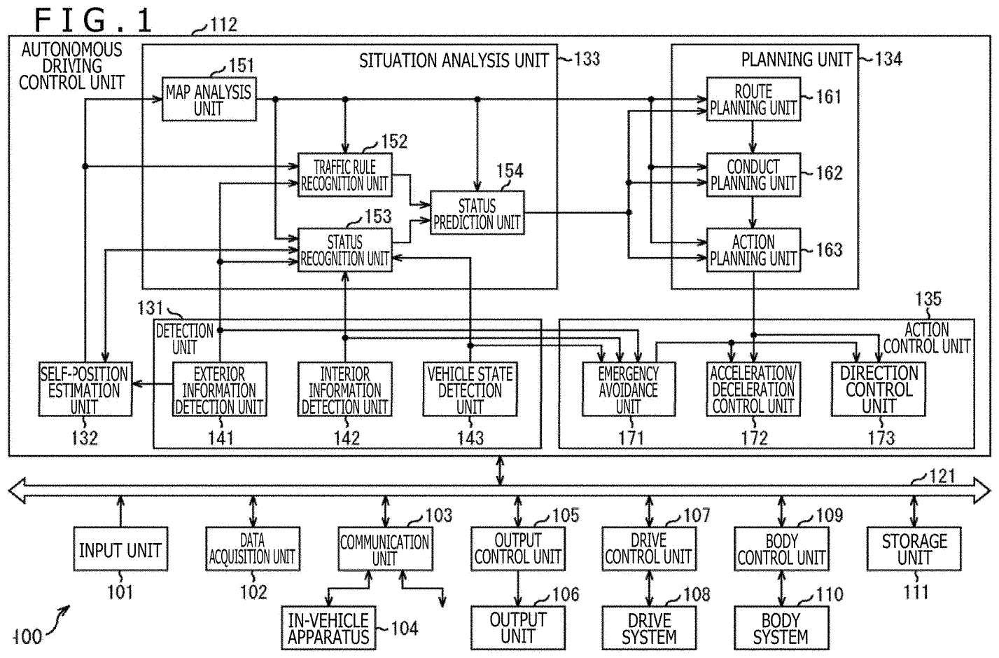

FIG. 1 is a block diagram depicting a schematic functional configuration example of a vehicle control system 100 as an example of a mobile body control system to which the present technology is applicable.

Note that a vehicle on which the vehicle control system 100 is provided will be hereinafter referred to as an own vehicle or an own vehicle in a case of a necessity of distinction between this vehicle and another vehicle.

The vehicle control system 100 includes an input unit 101, a data acquisition unit 102, a communication unit 103, an in-vehicle apparatus 104, an output control unit 105, an output unit 106, a drive control unit 107, a drive system 108, a body control unit 109, a body system 110, a storage unit 111, and an autonomous driving control unit 112. The input unit 101, the data acquisition unit 102, the communication unit 103, the output control unit 105, the drive control unit 107, the body control unit 109, the storage unit 111, and the autonomous driving control unit 112 are connected to one another via a communication network 121. For example, the communication network 121 includes an in-vehicle communication network, a bus, or the like in conformity with any standards, such as a CAN (Controller Area Network), a LIN (Local Interconnect Network), a LAN (Local Area Network), or FlexRay (registered trademark). Note that the respective units of the vehicle control system 100 in some circumstances are directly connected to one another without using the communication network 121.

Note that description of the communication network 121 will be hereinafter omitted in a case of communication between the respective units of the vehicle control system 100 via the communication network 121. For example, communication between the input unit 101 and the autonomous driving control unit 112 via the communication network 121 will be simply referred to as communication between the input unit 101 and the autonomous driving control unit 112.

The input unit 101 includes a device used for inputting various types of data, instructions, or the like from a person on board. For example, the input unit 101 includes an operation device such as a touch panel, a button, a microphone, a switch, and a lever, an operation device allowing input by a method other than a manual operation, such as voices and gestures, and others. Moreover, for example, the input unit 101 may be a remote control device using infrared light or other radio waves, or an external connection apparatus handling operations of the vehicle control system 100, such as a mobile apparatus and a wearable apparatus. The input unit 101 generates input signals on the basis of data, instructions, or the like input from the person on board, and supplies the generated input signals to the respective units of the vehicle control system 100.

The data acquisition unit 102 includes various types of sensors each for acquiring data used for processing by the vehicle control system 100, and supplies acquired data to the respective units of the vehicle control system 100.

For example, the data acquisition unit 102 includes various types of sensors each for detecting a state or the like of the own vehicle. Specifically, for example, the data acquisition unit 102 includes a gyro sensor, an acceleration sensor, an inertial measurement unit (IMU), and a sensor for detecting an operated amount of an acceleration pedal, an operated amount of a brake pedal, a steering angle of a steering wheel, an engine speed, a motor speed, a rotation speed of wheels, or the like.

Moreover, for example, the data acquisition unit 102 includes various types of sensors each for detecting information associated with the outside of the own vehicle. Specifically, for example, the data acquisition unit 102 includes an imaging device such as a ToF (Time Of Flight) camera, a stereo camera, a monocular camera, an infrared camera, and other cameras. Further, for example, the data acquisition unit 102 includes an environment sensor for detecting weather, meteorology, or the like, and an ambient information detection sensor for detecting an object around the own vehicle. For example, the environment sensor includes a raindrop sensor, a fog sensor, a sunlight sensor, or a snow sensor. For example, the ambient information detection sensor includes an ultrasonic sensor, a radar, a LiDAR (Light Detection and Ranging, Laser Imaging Detection and Ranging), or a sonar.

Moreover, for example, the data acquisition unit 102 includes various types of sensors each for detecting a current position of the own vehicle. Specifically, for example, the data acquisition unit 102 includes a GNSS (Global Navigation Satellite System) receiver for receiving GNSS signals from a GNSS satellite.

Moreover, for example, the data acquisition unit 102 includes various types of sensors each for detecting information associated with the vehicle interior. Specifically, for example, the data acquisition unit 102 includes an imaging device for imaging a driver, a biosensor for detecting biological information associated with the driver, and a microphone for collecting sounds in the vehicle interior. For example, the biosensor is provided on a seat surface, a steering wheel, or the like, and detects biological information associated with a person on board sitting on the seat, or the driver holding the steering wheel.

The communication unit 103 communicates with the in-vehicle apparatus 104, various apparatuses outside the vehicle, a server, a base station, or the like to transmit data supplied from the respective units of the vehicle control system 100, and supplies received data to the respective units of the vehicle control system 100. Note that a communication protocol supported by the communication unit 103 is not particularly limited, and that the communication unit 103 is allowed to support plural types of communication protocols.

For example, the communication unit 103 communicates with the in-vehicle apparatus 104 by wireless communication via a wireless LAN, Bluetooth (registered trademark), NFC (Near Field Communication), WUSB (Wireless USB), or the like. Moreover, for example, the communication unit 103 communicates with the in-vehicle apparatus 104 by wired communication via a not-depicted connection terminal (and a cable if necessary), by using a USB (Universal Serial Bus), an HDMI (High-Definition Multimedia Interface), an MHL (Mobile High-definition Link), or the like.

Moreover, for example, the communication unit 103 communicates with an apparatus (e.g., an application server or a control server) present in an external network (e.g., the Internet, a cloud network, or a unique network of a provider) via a base station or an access point. Further, for example, the communication unit 103 communicates with a terminal present near the own vehicle (e.g., a terminal of a pedestrian or a shop, or an MTC (Machine Type Communication) terminal), by using a P2P (Peer To Peer) technology. In addition, for example, the communication unit 103 establishes V2X communication such as vehicle-to-vehicle communication, vehicle-to-infrastructure communication, vehicle-to-home communication, and vehicle-to-pedestrian communication. Besides, for example, the communication unit 103 includes a beacon reception unit, and receives radio waves or electromagnetic waves transmitted from a wireless station or the like installed on a road to acquire information associated with a current position, a traffic jam, traffic restriction, a required time, or the like.

For example, the in-vehicle apparatus 104 includes a mobile apparatus or a wearable apparatus owned by the person on board, an information apparatus loaded or attached to the own vehicle, and a navigation device searching for a route to any destination.

The output control unit 105 controls output of various types of information to the person on board of the own vehicle or to the outside of the vehicle. For example, the output control unit 105 generates an output signal containing at least either visual information (e.g., image data) or auditory information (e.g., audio data), and supplies the generated output signal to the output unit 106 to control output of visual information and auditory information from the output unit 106. Specifically, for example, the output control unit 105 merges respective image data captured by different imaging devices of the data acquisition unit 102 to generate a bird's eye view image, a panorama image, or the like, and supplies an output signal containing the generated image to the output unit 106. Moreover, for example, the output control unit 105 generates audio data containing a warning sound, a warning message, or the like for a danger such as a collision, a contact, and entrance into a dangerous zone, and supplies an output signal containing the generated audio data to the output unit 106.

The output unit 106 includes a device capable of outputting visual information or auditory information to the person on board of the own vehicle or to the outside of the vehicle. For example, the output unit 106 includes a display device, an instrument panel, an audio speaker, headphones, a wearable device worn by the person on board such as a glass-type display, a projector, or a lamp. The display device included in the output unit 106 may be a device for displaying visual information within a visual field of the driver, such as a head-up display, a transmission-type display, a device having an AR (Augmented Reality) display function, as well as a device having an ordinary display.

The drive control unit 107 generates various types of control signals, and supplies the generated control signals to the drive system 108 to control the drive system 108. Moreover, the drive control unit 107 supplies control signals to the respective units other than the drive system 108 as necessary to notify these units of a control state of the drive system 108, for example.

The drive system 108 includes various types of devices each associated with a drive system of the own vehicle. For example, the drive system 108 includes a driving force generation device for generating a driving force, such as an internal combustion engine and a driving motor, a driving force transmission mechanism for transmitting the driving force to the wheels, a steering mechanism for adjusting the steering angle, a braking device for generating a braking force, an ABS (Antilock Brake System), an ESC (Electronic Stability Control), and an electric power steering device.

The body control unit 109 generates various types of control signals, and supplies the generated control signals to the body system 110 to control the body system 110. Moreover, the body control unit 109 supplies the control signals to the respective units other than the body system 110 as necessary to notify these units of a control state of the body system 110, for example.

The body system 110 includes various types of devices of the body system equipped on a vehicle body. For example, the body system 110 includes a keyless entry system, a smart key system, a power window device, power seats, a steering wheel, an air conditioning device, and various types of lamps (e.g., headlamps, back lamps, brake lamps, direction indicators, and fog lamps).

For example, the storage unit 111 includes a magnetic storage device such as a ROM (Read Only Memory), a RAM (Random Access Memory), and an HDD (Hard Disc Drive), a semiconductor storage device, an optical storage device, or a magneto-optical storage device. The storage unit 111 stores various types of programs, data, and the like used by the respective units of the vehicle control system 100. For example, the storage unit 111 stores map data such as a three-dimensional high-accuracy map like a dynamic map, a global map having accuracy lower than that of a high-accuracy map and covering a wide area, and a local map containing information around the own vehicle.

The autonomous driving control unit 112 performs control associated with autonomous driving such as autonomous traveling and drive assistance. Specifically, for example, the autonomous driving control unit 112 performs cooperative control for a purpose of achieving functions of an ADAS (Advanced Driver Assistance System) containing collision avoidance or shock reduction of the own vehicle, following traveling based on a distance between vehicles, constant speed traveling, warning of a collision with the own vehicle, warning of lane departure of the own vehicle, and the like. Moreover, for example, the autonomous driving control unit 112 performs cooperative control for a purpose of autonomous driving for achieving autonomous traveling without the necessity of an operation by the driver, or for other purposes. The autonomous driving control unit 112 includes a detection unit 131, a self-position estimation unit 132, a situation analysis unit 133, a planning unit 134, and an action control unit 135.

The detection unit 131 detects various types of information necessary for autonomous driving control. The detection unit 131 includes an exterior information detection unit 141, an interior information detection unit 142, and a vehicle state detection unit 143.

The exterior information detection unit 141 performs a detection process for detecting information associated with the outside of the own vehicle on the basis of data or signals received from the respective units of the vehicle control system 100. For example, the exterior information detection unit 141 performs a detection process for detecting an object around the own vehicle, a recognition process for recognizing the object, a tracking process for tracking the object, and a detection process for detecting a distance to the object. Examples of the object as a detection target include a vehicle, a human, an obstacle, a structure, a road, a traffic light, a traffic sign, and a road sign. Moreover, for example, the exterior information detection unit 141 performs a detection process for detecting an ambient environment around the own vehicle. Examples of the ambient environment as a detection target include weather, temperature, humidity, brightness, and a road surface state. The exterior information detection unit 141 supplies data indicating a result of the detection process to the self-position estimation unit 132, a map analysis unit 151, a traffic rule recognition unit 152, and a situation recognition unit 153 of the situation analysis unit 133, an emergency avoidance unit 171 of the action control unit 135, and others.

The interior information detection unit 142 performs a detection process for detecting information associated with the vehicle interior on the basis of data or signals received from the respective units of the vehicle control system 100. For example, the interior information detection unit 142 performs an authentication process and a recognition process for authenticating and recognizing the driver, a detection process for detecting a state of the driver, a detection process for detecting the person on board, and a detection process for detecting an environment of the vehicle interior. Examples of the state of the driver as a detection target include a physical condition, a wakefulness level, a concentration level, a fatigue level, and a visual line direction. Examples of the environment of the vehicle interior as a detection target include temperature, humidity, brightness, and a smell. The interior information detection unit 142 supplies data indicating a result of the detection process to the situation recognition unit 153 of the situation analysis unit 133, the emergency avoidance unit 171 of the action control unit 135, and others.

The vehicle state detection unit 143 performs a detection process for detecting a state of the own vehicle on the basis of data or signals received from the respective units of the vehicle control system 100. Examples of the state of the own vehicle as a detection target include a speed, acceleration, a steering angle, presence or absence of and contents of abnormality, a state of a driving operation, positions and inclinations of the power seats, a door lock state, and states of other in-vehicle apparatuses. The vehicle state detection unit 143 supplies data indicating a result of the detection process to the situation recognition unit 153 of the situation analysis unit 133, the emergency avoidance unit 171 of the action control unit 135, and the like.

The self-position estimation unit 132 performs an estimation process for estimating a position, a posture, and the like of the own vehicle on the basis of data or signals received from the respective units of the vehicle control system 100, such as the exterior information detection unit 141, and the situation recognition unit 153 of the situation analysis unit 133. Moreover, the self-position estimation unit 132 generates a local map used for estimation of the self position (hereinafter referred to as a self-position estimation map) as necessary. For example, the self-position estimation map is a high-accuracy map using a technology such as SLAM (Simultaneous Localization and Mapping). The self-position estimation unit 132 supplies data indicating a result of the estimation process to the map analysis unit 151, the traffic rule recognition unit 152, and the situation recognition unit 153 of the situation analysis unit 133, and others. Moreover, the self-position estimation unit 132 causes the storage unit 111 to store the self-position estimation map.

The situation analysis unit 133 performs an analysis process for analyzing situations of the own vehicle and surroundings. The situation analysis unit 133 includes the map analysis unit 151, the traffic rule recognition unit 152, the situation recognition unit 153, and a situation prediction unit 154.

The map analysis unit 151 performs an analysis process for analyzing various types of maps stored in the storage unit 111 while using data or signals received from the respective units of the vehicle control system 100, such as the self-position estimation unit 132 and the exterior information detection unit 141, as necessary to construct a map containing information necessary for processing of autonomous driving. The map analysis unit 151 supplies the constructed map to the traffic rule recognition unit 152, the situation recognition unit 153, the situation prediction unit 154, and a route planning unit 161, a conduct planning unit 162, and an action planning unit 163 of the planning unit 134, and others.

The traffic rule recognition unit 152 performs a recognition process for recognizing traffic rules around the own vehicle on the basis of data or signals received from the respective units of the vehicle control system 100, such as the self-position estimation unit 132, the exterior information detection unit 141, and the map analysis unit 151. For example, this recognition process achieves recognition of a position and a state of a traffic light around the own vehicle, contents of traffic restriction around the own vehicle, travelable lanes, and the like. The traffic rule recognition unit 152 supplies data indicating a result of the recognition process to the situation prediction unit 154 and others.

The situation recognition unit 153 performs a recognition process for recognizing a situation associated with the own vehicle on the basis of data or signals received from the respective units of the vehicle control system 100, such as the self-position estimation unit 132, the exterior information detection unit 141, the interior information detection unit 142, the vehicle state detection unit 143, and the map analysis unit 151. For example, the situation recognition unit 153 performs a recognition process for recognizing a situation of the own vehicle, a situation around the own vehicle, a situation of the driver of the own vehicle, and the like. Moreover, the situation recognition unit 153 generates a local map used for recognition of the situation around the own vehicle (hereinafter referred to as a situation recognition map) as necessary. For example, the situation recognition map is an occupancy grid map.

Examples of the situation of the own vehicle as a recognition target include a position, a posture, and movement (e.g., a speed, acceleration, and a moving direction) of the own vehicle, and presence or absence and contents of abnormality. Examples of the situation around the own vehicle as a recognition target include a type and a position of a surrounding still object, a type, a position, and movement (e.g., a speed, acceleration, and a moving direction) of a surrounding dynamic object, a configuration of a surrounding road and a road surface state, and ambient weather, temperature, humidity, and brightness. Examples of the state of the driver as a recognition target include a physical condition, a wakefulness level, a concentration level, a fatigue level, movement of a visual line, and a driving operation.

The situation recognition unit 153 supplies data indicating a result of the recognition process (containing the situation recognition map as necessary) to the self-position estimation unit 132, the situation prediction unit 154, and others. Moreover, the situation recognition unit 153 causes the storage unit 111 to store the situation recognition map.

The situation prediction unit 154 performs a prediction process for predicting a situation associated with the own vehicle on the basis of data or signals received from the respective units of the vehicle control system 100, such as the map analysis unit 151, the traffic rule recognition unit 152, and the situation recognition unit 153. For example, the situation prediction unit 154 performs a prediction process for predicting a situation of the own vehicle, a situation around the own vehicle, a situation of the driver, and the like.

Examples of the situation of the own vehicle as a prediction target include a behavior of the own vehicle, occurrence of abnormality, and a travelable distance. Examples of the situation around the own vehicle as a prediction target include a behavior of a dynamic object around the own vehicle, a change of a traffic light state, and a change of an environment such as weather. Examples of the situation of the driver as a prediction target include a behavior and a physical condition of the driver.

The situation prediction unit 154 supplies data indicating a result of the prediction process to the route planning unit 161, the conduct planning unit 162, and the action planning unit 163 of the planning unit 134, and others together with data received from the traffic rule recognition unit 152 and the situation recognition unit 153.

The route planning unit 161 plans a route to a destination on the basis of data or signals received from the respective units of the vehicle control system 100, such as the map analysis unit 151 and the situation prediction unit 154. For example, the route planning unit 161 establishes a route from a current position to a designated destination on the basis of a global map. Moreover, for example, the route planning unit 161 changes the route as necessary on the basis of a traffic jam, an accident, traffic restriction, a situation of construction or the like, a physical condition of the driver, and the like. The route planning unit 161 supplies data indicating the planned route to the conduct planning unit 162 and others.

The conduct planning unit 162 plans a conduct of the own vehicle for achieving safe traveling along the route planned by the route planning unit 161 within a planned time on the basis of data or signals received from the respective units of the vehicle control system 100, such as the map analysis unit 151 and the situation prediction unit 154. For example, the conduct planning unit 162 plans a start, a stop, a traveling direction (e.g., forward movement, backward movement, left turn, right turn, and direction change), a traveling lane, a traveling speed, passing, and the like. The conduct planning unit 162 supplies data indicating the planned conduct of the own vehicle to the action planning unit 163 and others.

The action planning unit 163 plans an action of the own vehicle for achieving the conduct planned by the conduct planning unit 162 on the basis of data or signals received from the respective units of the vehicle control system 100, such as the map analysis unit 151 and the situation prediction unit 154. For example, the action planning unit 163 plans acceleration, deceleration, a traveling track, and the like. The action planning unit 163 supplies data indicating the planned action of the own vehicle to an acceleration/deceleration control unit 172 and a direction control unit 173 of the action control unit 135, and others.

The action control unit 135 controls an action of the own vehicle. The action control unit 135 includes the emergency avoidance unit 171, the acceleration/deceleration control unit 172, and the direction control unit 173.

The emergency avoidance unit 171 performs a detection process for detecting an emergency such as a collision, a contact, entrance into a dangerous zone, abnormality of the driver, and abnormality of the vehicle on the basis of detection results obtained by the exterior information detection unit 141, the interior information detection unit 142, and the vehicle state detection unit 143. The emergency avoidance unit 171 plans an action of the own vehicle for avoiding an emergency, such as a sudden stop and a sharp turn, in a case where occurrence of an emergency has detected. The emergency avoidance unit 171 supplies data indicating the planned action of the own vehicle to the acceleration/deceleration control unit 172, the direction control unit 173, and others.

The acceleration/deceleration control unit 172 performs acceleration/deceleration control for achieving the action of the own vehicle planned by the action planning unit 163 or the emergency avoidance unit 171. For example, the acceleration/deceleration control unit 172 calculates a control target value of a driving force generation device or a braking device for achieving the planned acceleration, deceleration, or a sudden stop, and supplies a control command indicating the calculated control target value to the drive control unit 107.

The direction control unit 173 performs direction control for achieving the action of the own vehicle planned by the action planning unit 163 or the emergency avoidance unit 171. For example, the direction control unit 173 calculates a control target value of a steering mechanism for achieving a traveling track or a sharp turn planned by the action planning unit 163 or the emergency avoidance unit 171, and supplies a control command indicating the calculated control target value to the drive control unit 107.

For achieving autonomous driving and ADAS, a damage reduction brake function which senses an obstacle and prepares for a collision with the obstacle is essential for an automobile. According to the vehicle control system 100 depicted in FIG. 1, the emergency avoidance unit 171 recognizes an obstacle such as a pedestrian and a bicycle on the basis of a detection result obtained by the exterior information detection unit 141, and predicts a situation of occurrence of emergency including a collision of the obstacle, such as a situation where the pedestrian or the bicycle runs into a space in front of the own vehicle. Thereafter, the emergency avoidance unit 171 plans an action of the own vehicle for avoiding a collision with the predicted obstacle such as a pedestrian and a bicycle, and supplies data indicating the planned action of the own vehicle to the acceleration/deceleration control unit 172 and the direction control unit 173 to achieve the damage reduction brake function. Moreover, the vehicle control system 100 may be configured such that the output control unit 105 gives warning, such as output of audio data containing a warning sound, a warning message, or the like from the output unit 106, as well as the damage reduction brake function.

Generally, running out of an object such as a pedestrian and a bicycle toward the own vehicle, or a collision between the object and the own vehicle is predicted from movement of the object with respect to the traveling lane of the own vehicle. In this case, it is easy to predict running out of a pedestrian or a bicycle directed toward the front of the own vehicle or the traveling lane of the own vehicle. For example, it is easy to predict running of a pedestrian or a bicycle perpendicularly approaching a lane on which the own vehicle is traveling. On the other hand, it is difficult to predict running out of a pedestrian or a bicycle not directed toward the traveling lane of the own vehicle. For example, it is difficult to predict running out of a pedestrian or a bicycle which is in a stopped state, or a pedestrian or a bicycle which is not advancing in the direction of the own vehicle but is likely to run out.

Accordingly, the present description proposes a technology which determines a possibility of running out of a pedestrian or a bicycle on the basis of history information associated with a region in contact with an object such as a pedestrian and a bicycle, and estimates a range of running out.

Moreover, the technology proposed in the present description uses semantic segmentation to process information in a preferable manner for each region. Semantic segmentation is a technology for identifying which category a pixel belongs for each pixel of an image. Specifically, semantic segmentation identifies which category a pixel belongs for each pixel in an image on the basis of dictionary data for object identification based on shapes and other features of various types of actual objects, and on the basis of a matching level between the actual objects and an object in the image.

Semantic segmentation which identifies an object for each pixel is characterized by an ability of identification achievable with granularity finer than that of an ordinary object recognition technology using a camera image or the like. Moreover, semantic segmentation is characterized by an ability of preferable identification for an overlapped portion between objects, i.e., highly accurate identification of an object located behind a front object and visible only partially.

For example, use of the semantic segmentation technology allows identification of a region of a pedestrian in an image of the front of the own vehicle captured by an in-vehicle camera, and further allows acquisition of detailed information indicating a region in ground contact with the pedestrian (e.g., sidewalk or driveway), and also a region with which the pedestrian is likely to come into ground contact.

The technology disclosed in the present description acquires detailed history information associated with a region in contact with an object such as a pedestrian and a bicycle, and performs conduct prediction of the pedestrian or the bicycle on the basis of the history information to find a potential danger, or a pedestrian or a bicycle in an early stage.

### Embodiment 1

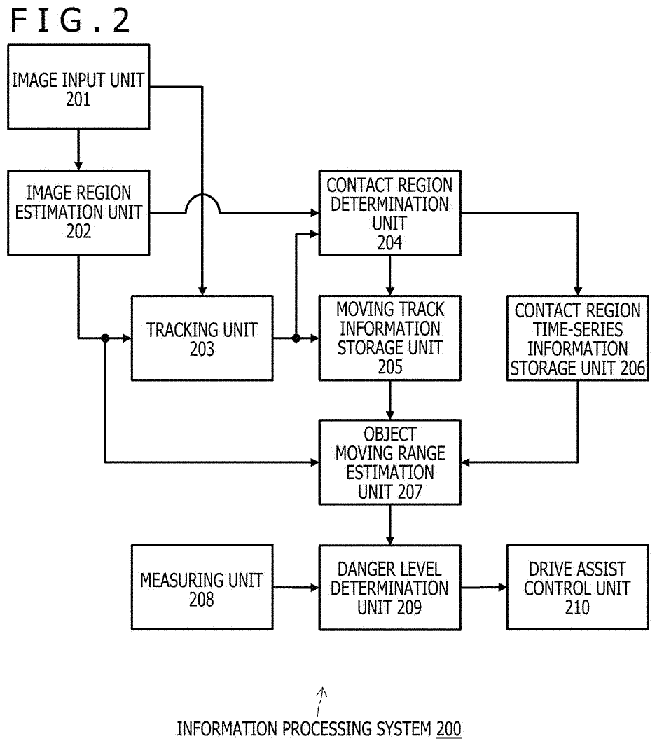

FIG. 2 depicts a functional configuration example of an information processing system 200 according to a first embodiment. The information processing system 200 has a function of estimating a moving range of an object such as a pedestrian and a bicycle (i.e., range of possible running out) on the basis of image information indicating surroundings of the own vehicle and captured by an in-vehicle camera, for example. Drive assistance such as warning to the driver, brake assist operation, or control of automatic operation is achievable on the basis of an estimation result obtained by the information processing system 200.

The information processing system 200 depicted in the figure includes an image input unit 201, an image region estimation unit 202, a tracking unit 203, a contact region determination unit 204, a moving track information storage unit 205, a contact region time-series information storage unit 206, an object moving range estimation unit 207, a measuring unit 208, a danger level determination unit 209, and a drive assist control unit 210.

At least some of constituent elements of the information processing system 200 are implemented using constituent elements included in the vehicle control system 100. Moreover, some of the constituent elements of the information processing system 200 may also be implemented using an information terminal carried into the vehicle interior by the person on board, such as a smartphone and a tablet, or other information apparatuses. Further, at least some of the constituent elements of the information processing system 200 may also be implemented in a form of what is generally called a program code executed in a computer. In addition, it is assumed that bidirectional data communication between the respective constituent elements of the information processing system 200 is achievable via a bus or using interprocess communication. The respective constituent elements included in the information processing system 200 will be hereinafter described.

The image input unit 201 inputs image information indicating surroundings of the own vehicle, such as an image captured by an in-vehicle camera. However, it is not required to directly input the image information from an image sensor. It is allowed to use three-dimensional shape information obtained by stereoscopy or using a distance sensor such as a TOF sensor and a LiDAR, two-dimensional bird's eye view information obtained by conversion into a two-dimensional bird's eye view figure, equivalent and identical map information, or three-dimensional shape information using time-series measurement information and SLAM or SfM (Structure from Motion).

The image region estimation unit 202 estimates respective regions in an image input via the image input unit 201. For estimation of the image regions, a category to which a pixel belongs is identified for each pixel of the image, basically using the semantic segmentation technology. Information to which a label for identifying a category for each pixel has been given is output from the image region estimation unit 202. Objects are extracted on the basis of an estimation result of the image region estimation unit 202. The object referred to herein is a predicted object which may collide with the own vehicle, such as a pedestrian and a bicycle.

The tracking unit 203 tracks, using the image input via the image input unit 201, respective objects extracted on the basis of an estimation result obtained by the image region estimation unit 202.

The contact region determination unit 204 determines a contact region of each of the objects, by using the estimation result obtained by the image region estimation unit 202, i.e., semantic segmentation, on the basis of a tracking result of the objects obtained by the tracking unit 203. Specifically, the contact region determination unit 204 determines which is a contact region on the basis of label information given to the contact region of each of the objects. For example, it is determined which of a sidewalk, a driveway, and others is a ground contact surface of each of the objects such as a pedestrian and a bicycle.

The moving track information storage unit 205 stores, for each of the objects, information associated with a moving track of each of the objects and extracted by the tracking unit 203. For example, a position of each of the objects is represented as position information in an x-y coordinate system of a world coordinate system. In addition, information associated with the moving track is represented as position information associated with each of the objects for each predetermined interval (time interval or distance interval).

The contact region time-series information storage unit 206 stores, for each of the objects, time-series information associated with the contact region of each of the objects and determined by the contact region determination unit 204. The time-series information associated with the contact region of each of the objects is represented as category information associated with the contact region of the corresponding object for each predetermined interval (time interval or distance interval). Moreover, the time-series information associated with the contact region of each of the objects may contain speed information associated with the corresponding object.

The object moving range estimation unit 207 estimates a moving range of each of the objects, by using the estimation result obtained by the image region estimation unit 202, i.e., semantic segmentation, on the basis of at least either the information associated with the contact region of the corresponding object and stored in the moving track information storage unit 205, or the time-series information associated with the contact region of the corresponding object and stored in the contact region time-series information storage unit 206, and outputs the estimated or predicted moving range of each of the objects. In a case where the time-series information associated with the contact region of the object contains speed information indicating the speed of the object, the object moving range estimation unit 207 may estimate the moving range also in consideration of the speed information associated with the object.

For example, the object moving range estimation unit 207 estimates the moving range of each of the objects on the basis of rules. The rules referred to herein include “a pedestrian moving from a sidewalk to a driveway crosses the driveway and reaches an opposite sidewalk,” “when a guardrail is present between a sidewalk and a driveway, a pedestrian skips over the guardrail and reaches the driveway,” and “a pedestrian passes while avoiding grounds (unpaved portions) or puddles present scattered on the sidewalk,” for example. The rules may be rules described on the basis of semantics of a region in contact with or in ground contact with the object. Moreover, at the time of estimation of the moving range of each of the objects on the basis of rules, a moving track of the object (speed information based on the moving track) or time-series information associated with the contact region is used as a correction coefficient. Further, the object moving range estimation unit 207 may estimate the moving range of the object by machine learning. The machine learning uses a neural network. In a case of machine learning of time-series information associated with the contact region or the like, recurrent neural network (RNN) may be used.

The measuring unit 208 measures a steering angle and a vehicle speed of the own vehicle. The measuring unit 208 may be the data acquisition unit 102 (described above) in the vehicle control system 100. Alternatively, the measuring unit 208 may be replaced with a function module which inputs vehicle control information such as a steering angle and a vehicle speed from the vehicle control system 100.

The danger level determination unit 209 determines a danger level of a collision with the own vehicle for each of the objects on the basis of a comparison result between the moving range of each of the objects estimated by the object moving range estimation unit 207 and the vehicle control information associated with the own vehicle such as a steering angle and a vehicle speed. Specifically, the danger level determination unit 209 predicts a future reaching range of the own vehicle on the basis of the vehicle control information associated with the own vehicle such as a steering angle and a vehicle speed, searches for an intersection of the predicted future reaching range and the estimated moving range of each of the objects, and determines that there is a danger of a collision between the own vehicle and the object corresponding to an intersection having been found.

The drive assist control unit 210 assists driving of the own vehicle on the basis of a determination result obtained by the danger level determination unit 209. The drive assist control unit 210 may be the emergency avoidance unit 171 (described above) in the vehicle control system 100. The emergency avoidance unit 171 plans an action of the own vehicle for avoiding a collision with the object determined to possibly collide with the own vehicle, and supplies data indicating the planned action of the own vehicle to the acceleration/deceleration control unit 172 and the direction control unit 173 to achieve the damage reduction brake function. Moreover, the vehicle control system 100 may also be configured such that the output control unit 105 gives warning, such as output of audio data containing a warning sound, a warning message, or the like from the output unit 106, as well as the damage reduction brake function.

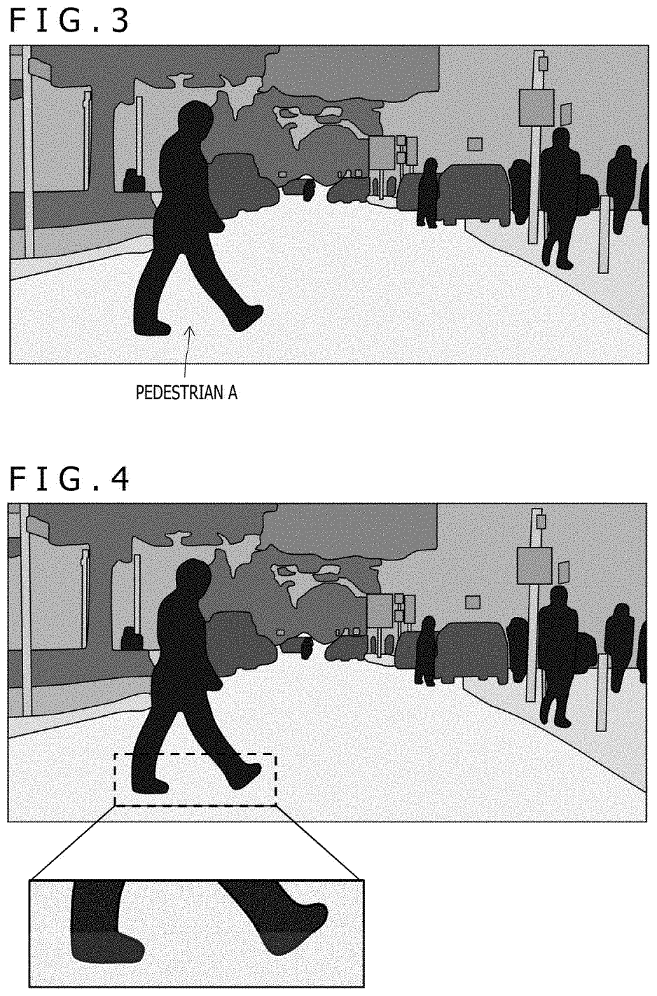

A specific operation example of the information processing system 200 according to the first embodiment will be subsequently described. It is assumed herein that the image region estimation unit 202 has performed semantic segmentation for an image input by the image input unit 201 from the in-vehicle camera, and obtained an image containing regions divided for each semantics as depicted in FIG. 3. A label identifying a category is given to each pixel. In FIG. 3, regions having the same label are represented with the same shading. Moreover, a regional image depicted in FIG. 3 contains a pedestrian A crossing a driveway in front of the own vehicle. Described hereinafter will be a process for estimating a moving range of the pedestrian A by using the information processing apparatus 200.

The contact region determination unit 204 determines a contact region of each of the objects, by using the estimation result obtained by the image region estimation unit 202, i.e., semantic segmentation, on the basis of a tracking result of the objects obtained by the tracking unit 203. Specifically, the contact region determination unit 204 determines which of a sidewalk, a driveway, and others is a ground contact surface of the pedestrian A. Information associated with the ground contact surface is information indicating a label given to a pixel in a contact region of the feet of the pedestrian A. Alternatively, this information may be a cut image of a contact region itself between the feet of the pedestrian A and the ground as depicted in FIG. 4. According to the regional image depicted in FIG. 3, it is determined that the ground contact surface of the pedestrian A is a driveway.

Thereafter, the contact region time-series information storage unit 206 stores time-series information associated with the contact region of the pedestrian A and determined by the contact region determination unit 204. The time-series information associated with the contact region of the pedestrian A includes category information indicating the ground contact surface of the pedestrian A and obtained for every predetermined time.

In addition, the moving track information storage unit 205 stores information associated with a moving track of the pedestrian A and extracted by the tracking unit 203 from the regional image depicted in FIG. 3. The information associated with the moving track includes position information associated with the pedestrian A and obtained for each predetermined interval.

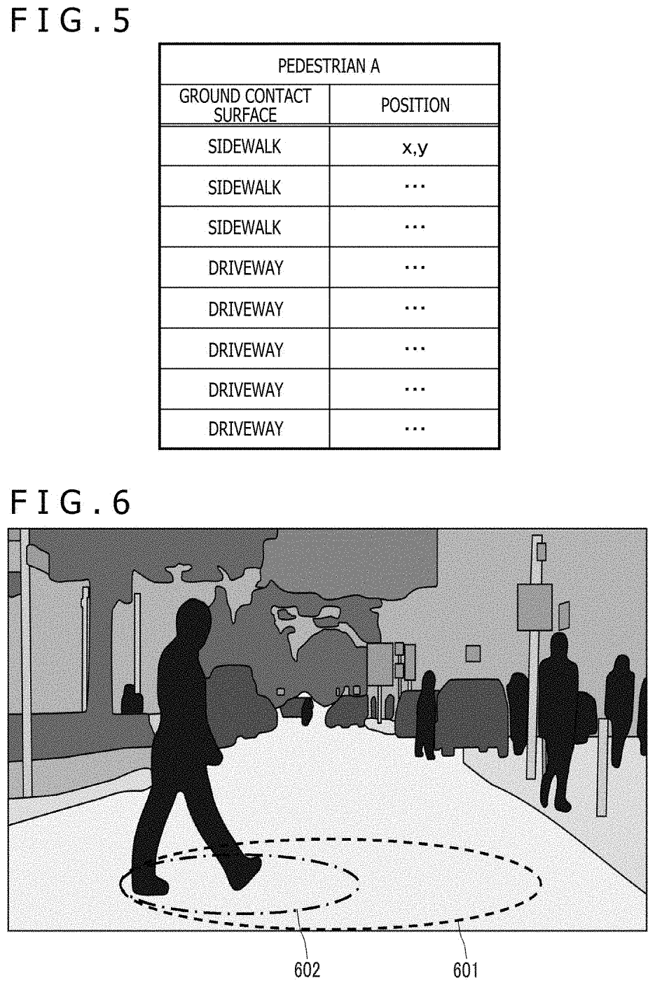

History information indicating a history of the ground contact surface of the pedestrian A as depicted in FIG. 5 can be created on the basis of the time-series information associated with the contact region of the pedestrian A and read from the contact region time-series information storage unit 206, and the moving track information associated with the pedestrian A and read from the moving track information storage unit 205. FIG. 5 includes a combination of a category of the ground contact surface of the pedestrian A and position information for each predetermined interval. A downward direction in the figure represents a time-axis direction. History information indicating a history of transitions of the pedestrian A on the ground contact surface changing in an order of the sidewalk, the sidewalk, the sidewalk, the driveway, the driveway, the driveway, and others is stored.

The object moving range estimation unit 207 estimates a moving range of the pedestrian A on the basis of the history information indicating the history of the ground contact surface of the pedestrian A as depicted in FIG. 5. For example, the object moving range estimation unit 207 estimates the moving range of the object on the basis of rules. The rules may be rules described on the basis of semantics of a region in contact with or in ground contact with the object. Moreover, at the time of estimation of the moving range of the object on the basis of rules, a moving track of the object (speed information based on the moving track) or time-series information associated with the contact region is used as a correction coefficient. Further, the object moving range estimation unit 207 may estimate the moving range of the object by machine learning. The machine learning uses a neural network. In a case of machine learning of time-series information associated with the contact region or the like, RNN may be used.

FIG. 6 depicts a moving range 601 of the pedestrian A estimated by the object moving range estimation unit 207 on the basis of the contact region time-series information associated with the pedestrian A (see FIG. 5). Moreover, this figure also depicts a moving range 602 of the pedestrian A estimated on the basis of speed information associated with the pedestrian A.

The moving range of the pedestrian A estimated on the basis of the speed information is a moving range of the pedestrian derived from a walking speed vector of the pedestrian A estimated on the basis of position information (i.e., moving track information associated with the pedestrian A) in a right column of the contact region time-series information depicted in FIG. 5. In this case, a direction and an area of this moving range are limited.

On the other hand, in a case of estimation based on the contact region time-series information, the moving range 601 of the pedestrian can be estimated not only simply on the basis of the position information associated with the pedestrian A, but also in consideration of a category or semantics of a region coming into ground contact with the pedestrian A from moment to moment. For example, the moving range 601 of the pedestrian can be estimated on the basis of such a general pedestrian tendency or a personal tendency of the pedestrian A that walking accelerates in the middle of crossing when a history of a change of the ground contact surface from the sidewalk to the driveway is produced. Estimation of the moving range of the pedestrian A by using the information processing system 200 offers such an advantageous effect that a danger of running out of the pedestrian A as a result of acceleration in the middle of crossing the driveway is detectable in an early stage.

Note that, in the example depicted in FIG. 6, the moving range 601 is wider than the moving range 602 estimated only on the basis of speed information because of a tendency that the pedestrian A accelerates in the middle of crossing. However, in a case of a history of the ground contact surface where the conduct of the pedestrian A is limited, it is also assumed that the direction and the area become narrower in the moving range estimated on the basis of the contact region time-series information than those in the moving range estimated on the basis of the speed information.

The measuring unit 208 measures a steering angle and a vehicle speed of the own vehicle. Thereafter, the danger level determination unit 209 predicts a future reaching range of the own vehicle on the basis of the vehicle control information associated with the own vehicle such as a steering angle and a vehicle speed, searches for an intersection of the predicted future reaching range and the estimated moving range 601 (described above) of the pedestrian A, and determines that there is a danger of a collision between the pedestrian A and the own vehicle in a case where an intersection has been detected.

In a case where the danger level determination unit 209 determines that there is a danger of a collision between the pedestrian A and the own vehicle, the drive assist control unit 210 plans an action of the own vehicle for avoiding a collision between the own vehicle and the pedestrian A, and supplies data indicating the planned action of the own vehicle to the acceleration/deceleration control unit 172 and the direction control unit 173 to achieve damage reduction braking. Moreover, the drive assist control unit 210 may also be configured to give warning, such as output of audio data containing a warning sound, a warning message, or the like from the output unit 106, as well as damage reduction braking.

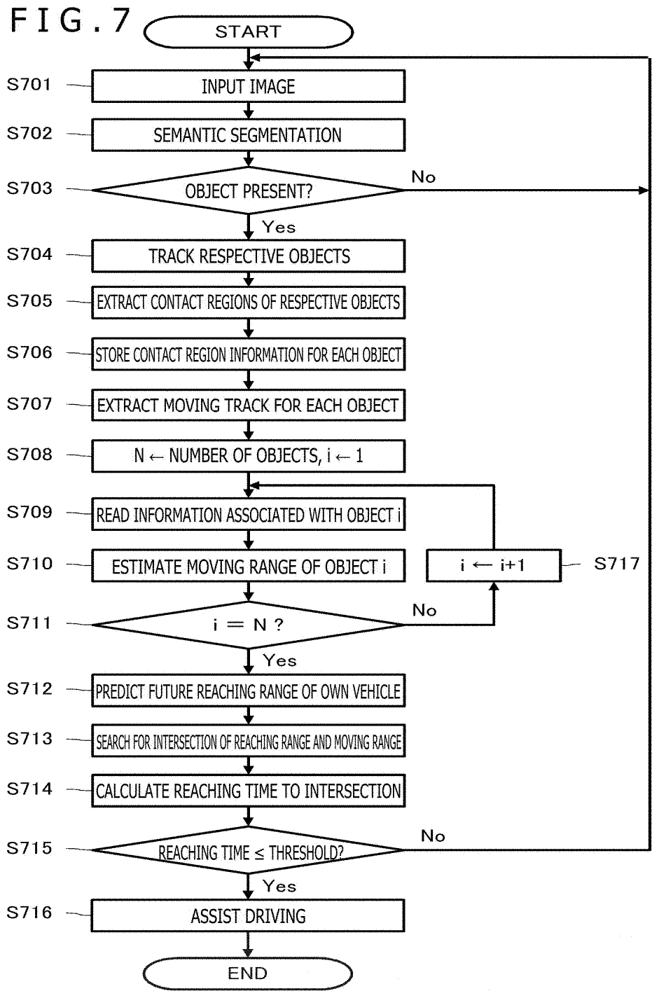

FIG. 7 presents a processing procedure performed by the information processing system 200 in a form of a flowchart.

Initially, the image input unit 201 inputs image information associated with surroundings of the own vehicle, such as an image captured by an in-vehicle camera (step S701).

Subsequently, the image region estimation unit 202 performs a semantic segmentation process for the input image, and outputs a processing result (step S702).

Thereafter, the tracking unit 203 checks whether or not an object is present in a regional image obtained by the semantic segmentation process (step S703). The object referred to herein is a predicted object which may collide with the own vehicle, such as a pedestrian, a bicycle, and a surrounding vehicle.

In a case where no object has been found (No in step S703), the process returns to step S701 and inputs a next image.

On the other hand, in a case where objects have been found (Yes in step S703), the tracking unit 203 extracts information associated with the objects from the regional image obtained by the semantic segmentation process, and tracks the respective objects by using the image input in step S701 (step S704).

The contact region determination unit 204 extracts information associated with contact regions of the respective objects on the basis of an estimation result obtained by the image region estimation unit 202 and a tracking result of the objects obtained by the tracking unit 203 (step S705).

Then, the contact region time-series information storage unit 206 stores, for each of the objects, time-series information associated with the contact region of each of the objects extracted by the contact region determination unit 204 (step S706).

Moreover, the moving track information storage unit 205 stores, for each of the objects, information associated with a moving track of each of the objects and extracted by the tracking unit 203 (step S707).

Subsequently, the total number of the objects found in step S703 is substituted for a variable N, and an initial value 1 is substituted for a variable i which is a count number of the processed objects (step S708).

Thereafter, moving history information and contact region time-series information associated with the ith object are read from the moving history information storage unit 205 and the contact region time-series information storage unit 206, respectively (step S709), and a moving range of the ith object is estimated by the object moving range estimation unit 207 (step S710).

In a case where i is smaller than N, i.e., unprocessed objects still remain herein (No in step S711), i is incremented only by 1 (step S717). Then, the process returns to step S709 to repeatedly perform an estimation process for estimating a moving range of a next object.

On the other hand, when i reaches N, i.e., in a case where the moving range estimation process has been completed for all of the objects (Yes in step S711), a danger level determination process is subsequently performed for each of the objects.

Initially, the danger level determination unit 209 predicts a future reaching range of the own vehicle on the basis of vehicle control information associated with the own vehicle, such as a steering angle and a vehicle speed (step S712).

Subsequently, the danger level determination unit 209 searches for an intersection of the predicted future reaching range of the own vehicle and the estimated moving range of each of the objects (step S713).

Thereafter, in a case where an intersection has been detected, the danger level determination unit 209 calculates a time required for the own vehicle to reach this intersection (step S714).

Then, the danger level determination unit 209 compares a length of the time required for the own vehicle to reach the intersection with a predetermined threshold (step S715).

In a case where the time required for the own vehicle to reach the intersection is equal to or shorter than the threshold (Yes in step S715), the danger level determination unit 209 determines that there is a danger of a collision between the own vehicle and the object. In this case, the drive assist control unit 210 assists driving of the own vehicle on the basis of a determination result obtained by the danger level determination unit 209 (step S716).

The drive assist control unit 210 plans an action of the own vehicle for avoiding a collision with the object determined to possibly collide with the vehicle, and supplies data indicating the planned action of the own vehicle to the acceleration/deceleration control unit 172 and the direction control unit 173 to achieve the damage reduction brake function. Moreover, the output control unit 105 may output warning, such as output of audio data containing a warning sound, a warning message, or the like, from the output unit 106 as well as the damage reduction brake function.

Further, when the time required for the own vehicle to reach the intersection is longer than the threshold (No in step S715), the danger level determination unit 209 determines that there is no danger of a collision between the own vehicle and the object. In this case, the process returns to step S701 to repeatedly execute tracking of objects, estimation of moving ranges of objects, and the danger level determination process as described above.

### Embodiment 2

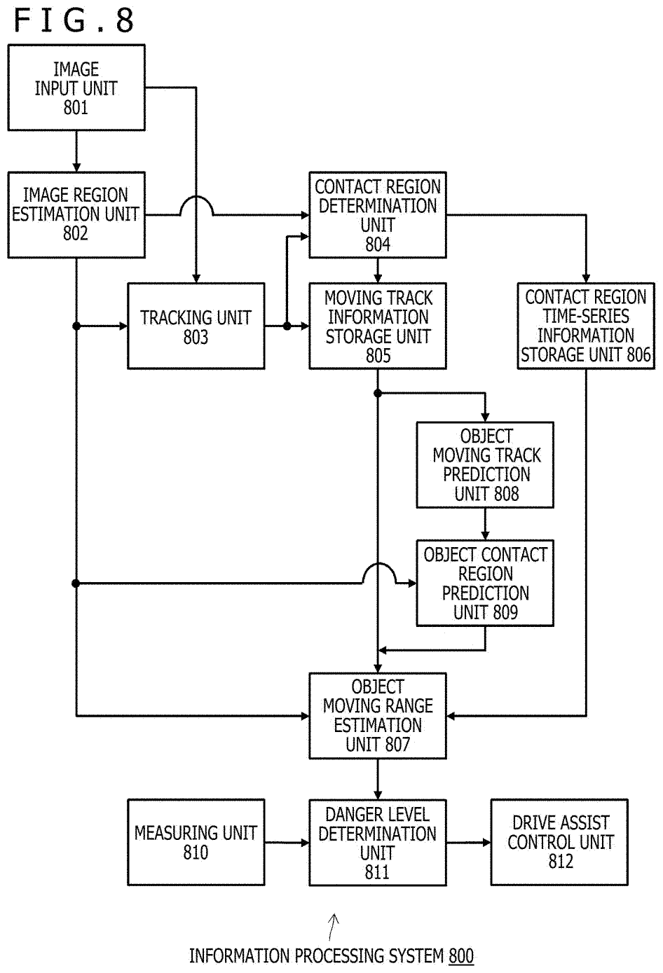

FIG. 8 depicts a functional configuration example of an information processing system 800 according to a second embodiment. The information processing system 800 has a function of estimating a moving range of an object such as a pedestrian and a bicycle on the basis of image information associated with surroundings of the own vehicle and captured by an in-vehicle camera, for example. Drive assistance such as warning to the driver, brake assist operation, and control of automatic operation is achievable on the basis of an estimation result obtained by the information processing system 800.

The information processing system 800 depicted in the figure includes an image input unit 801, an image region estimation unit 802, a tracking unit 803, a contact region determination unit 804, a moving track information storage unit 805, a contact region time-series information storage unit 806, an object moving range estimation unit 807, an object moving track prediction unit 808, an object contact region prediction unit 809, a measuring unit 810, a danger level determination unit 811, and a drive assist control unit 812.

At least some of constituent elements of the information processing system 800 are implemented using constituent elements included in the vehicle control system 100. Moreover, some of the constituent elements of the information processing system 800 may also be implemented using an information terminal carried into the vehicle interior by the person on board, such as a smartphone and a tablet, or other information apparatuses. In addition, it is assumed that bidirectional data communication between the respective constituent elements of the information processing system 800 is achievable via a bus, or using interprocess communication. The respective constituent elements included in the information processing system 800 will be hereinafter described.

The image input unit 801 inputs image information associated with surroundings of the own vehicle, such as an image captured by an in-vehicle camera. However, it is not required to directly input the image information from an image sensor. Three-dimensional shape information obtained by stereoscopy or using a distance sensor such as a TOF sensor and a LiDAR, two-dimensional bird's eye view information obtained by conversion into a two-dimensional bird's eye view figure, equivalent and identical map information, or three-dimensional shape information using time-series measurement information and SLAM or SfM may be used.

The image region estimation unit 802 estimates respective regions in the image input via the image input unit 801 by using the semantic segmentation technology, and outputs, for each pixel, information to which a label for identifying a category has been added. Objects are extracted on the basis of an estimation result obtained by the image region estimation unit 802.

The tracking unit 803 tracks, using the image input via the image input unit 801, respective objects extracted on the basis of the estimation result obtained by the image region estimation unit 802.

The contact region determination unit 804 determines a contact region of each of the objects by using an estimation result obtained by the image region estimation unit 802 on the basis of a tracking result of the objects obtained by the tracking unit 803. For example, it is determined which of a sidewalk, a driveway, and others is a ground contact surface of each of the objects such as a pedestrian and a bicycle.

The moving track information storage unit 805 stores, for each of the objects, information associated with a moving track of the object and extracted by the tracking unit 803. Moreover, the contact region time-series information storage unit 806 stores, for each of the objects, time-series information associated with the contact region of each of the objects and determined by the contact region determination unit 804.

The object moving track prediction unit 808 predicts a future moving track of each of the objects on the basis of moving track information associated with each of the objects and stored in the moving track information storage unit 805. The object moving regulation prediction unit 808 may predict the moving track of each of the objects by machine learning. The machine learning uses a neural network. For machine learning of time-series information such as a moving track, RNN may be used.

The object contact region prediction unit 809 predicts a contact region sequentially coming into contact on the future moving track of each of the objects predicted by the object moving track prediction unit 808 on the basis of the future moving track of each of the objects predicted by the object moving track prediction unit 808 and the estimation result obtained by the image region estimation unit 802. The object contact region prediction unit 809 may predict the contact region of each of the objects by machine learning. The machine learning uses a neural network.

The object moving range estimation unit 807 estimates a moving range of each of the objects by using the estimation result obtained by the image region estimation unit 802 on the basis of information associated with the contact region of the object and stored in the moving track information storage unit 805, time-series information associated with the contact region of the object and stored in the contact region time-series information storage unit 806, and further a future moving track predicted by the object moving track prediction unit 808 and a future contact region predicted by the object contact region prediction unit 809, and outputs the estimated or predicted moving range of each of the objects. In a case where the time-series information associated with the contact region of each of the objects contains speed information associated with the object, the object moving range estimation unit 807 may estimate the moving range in consideration of the speed information associated with the object.

For example, the object moving range estimation unit 807 estimates the moving range of each of the objects on the basis of rules. Moreover, at the time of estimation of the moving range of each of the objects on the basis of rules, a moving track of the object (speed information based on the moving track) or time-series information associated with the contact region is used as a correction coefficient of linear prediction. Further, the object moving range estimation unit 807 may estimate the moving range of each of the objects by machine learning. The machine learning uses a neural network. In a case of machine learning of time-series information associated with the contact region or the like, RNN may be used.

The measuring unit 810 measures a steering angle and a vehicle speed of the own vehicle. The measuring unit 810 may be the data acquisition unit 102 (described above) in the vehicle control system 100. Alternatively, the measuring unit 810 may be replaced with a function module which inputs vehicle control information such as a steering angle and a vehicle speed from the vehicle control system 100.

The danger level determination unit 811 determines, for each of the objects, a danger level of a collision with the own vehicle on the basis of a comparison result between the moving range of each of the objects estimated by the object moving range estimation unit 807 and the vehicle control information associated with the own vehicle such as a steering angle and a vehicle speed. Specifically, the danger level determination unit 811 predicts a future reaching range of the own vehicle on the basis of the vehicle control information associated with the own vehicle such as a steering angle and a vehicle speed, searches for an intersection of the predicted future reaching range and the estimated moving range of each of the objects, and determines that there is a danger of a collision between the own vehicle and the object corresponding to an intersection having been found.

The drive assist control unit 812 assists driving of the own vehicle on the basis of a determination result obtained by the danger level determination unit 811. The drive assist control unit 812 may be the emergency avoidance unit 171 (described above) in the vehicle control system 100. The emergency avoidance unit 171 plans an action of the own vehicle for avoiding a collision with the object determined to possibly collide with the own vehicle, and supplies data indicating the planned action of the own vehicle to the acceleration/deceleration control unit 172 and the direction control unit 173 to achieve the damage reduction brake function. Moreover, the vehicle control system 100 may also be configured such that the output control unit 105 gives warning, such as output of audio data containing a warning sound, a warning message, or the like, from the output unit 106 as well as the damage reduction brake function.

A specific operation example of the information processing system 800 according to the second embodiment will be subsequently described. It is also assumed herein that the image region estimation unit 802 has performed semantic segmentation for an image input from the image input unit 801, and obtained the regional image depicted in FIG. 3. A label for identifying a category is given to each pixel. Further described will be a process for estimating a moving range of the pedestrian A by using the information processing system 800.

The contact region determination unit 804 determines a contact region of the pedestrian A by using an estimation result obtained by the image region estimation unit 802 on the basis of a tracking result of the object obtained by the tracking unit 803. Specifically, the contact region determination unit 804 determines which of a sidewalk, a driveway, and others is a ground contact surface of the pedestrian A. Information associated with the ground contact surface is information indicating a label given to a pixel in a contact region of the feet of the pedestrian A. According to the regional image depicted in FIG. 3, it is determined that the ground contact surface of the pedestrian A is a driveway. Thereafter, the contact region time-series information storage unit 806 stores time-series information associated with the contact region of the pedestrian A and determined by the contact region determination unit 804. The time-series information associated with the contact region of the pedestrian A includes information indicating a category of the ground contact surface of the pedestrian A and obtained for every predetermined time.

In addition, the moving track information storage unit 805 stores information associated with a moving track of the pedestrian A and extracted by the tracking unit 803 from the regional image depicted in FIG. 3. The information associated with the moving track includes position information associated with the pedestrian A and obtained for each predetermined interval.

On the other hand, the object moving track prediction unit 808 predicts a future moving track of the pedestrian A on the basis of moving track information associated with the pedestrian A and stored in the moving track information storage unit 805. Moreover, the object contact region prediction unit 809 predicts a contact region sequentially coming into contact on the future moving track of the pedestrian A predicted by the object moving track prediction unit 808 on the basis of the estimation result obtained by the image region estimation unit 802.

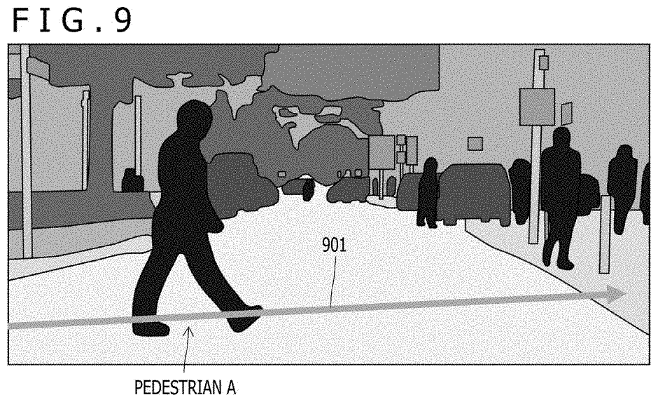

FIG. 9 depicts an example of a result of prediction of the moving track and the contact region of the pedestrian A for the regional image depicted in FIG. 3. Predicted in the example depicted in FIG. 9 is a moving track 901 where the pedestrian A walking while crossing the driveway will reach the sidewalk on the opposite side (walking direction) in the future, and also predicted is the sidewalk as a future contact region of the pedestrian A.

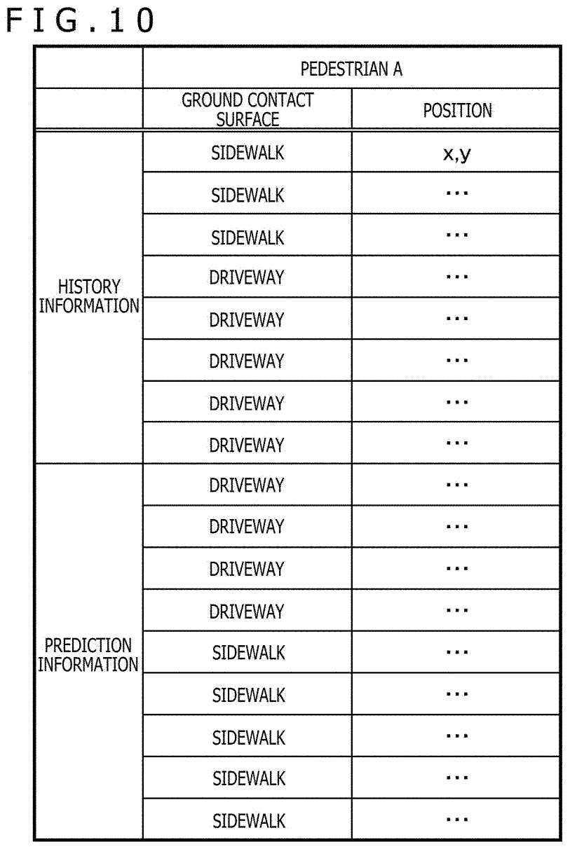

History information indicating a history of the ground contact surface of the pedestrian A as depicted in an upper half of FIG. 10 can be created on the basis of the time-series information associated with a contact region of the pedestrian A and read from the contact region time-series information storage unit 806, and the moving track information associated with the pedestrian A and read from the moving track information storage unit 805.

Moreover, prediction information associated with the ground contact surface of the pedestrian A as depicted in a lower half of the FIG. 10 can be created on the basis of a future moving track of the pedestrian A predicted by the object moving track prediction unit 808, and a future contact region of the pedestrian A predicted by the object contact region prediction unit 809. Predicted in the example depicted in FIG. 10 is a moving track where the pedestrian A walking while crossing the driveway will reach the sidewalk on the opposite side (walking direction) in the future, and also predicted is the sidewalk as a future contact region of the pedestrian A.

Each of the history information and the prediction information depicted in FIG. 10 includes a combination of a category of the ground contact surface of the pedestrian A and position information for each predetermined interval. A downward direction in the figure represents a time-axis direction. History information indicating a history of transitions of the pedestrian A on the ground contact surface changing in an order of the sidewalk, the sidewalk, the sidewalk, the driveway, the driveway, the driveway, and others is stored. In addition, it is predicated that the pedestrian A will transit on the ground contact surface in an order of the driveway, the driveway, the driveway, the driveway, the sidewalk, the sidewalk, and others in the future. While FIG. 10 depicts only one prediction pattern, each of the object moving track prediction unit 808 and the object contact region prediction unit 809 may predict plural prediction patterns.

The object moving range estimation unit 807 estimates the moving range of the pedestrian A on the basis of the history information and the prediction information associated with the ground contact surface of the pedestrian A as depicted in FIG. 10. For example, the object moving range estimation unit 807 estimates the moving range of each of the objects on the basis of rules. The rules may be rules described on the basis of semantics of a region in contact with or in ground contact with the object. Moreover, at the time of estimation of the moving range of the object on the basis of rules, a moving track of the object (speed information based on the moving track) or time-series information associated with the contact region is used as a correction coefficient. Further, the object moving range estimation unit 807 may estimate the moving range of each of the objects by machine learning. The machine learning uses a neural network. In a case of machine learning of time-series information associated with the contact region or the like, RNN may be used.

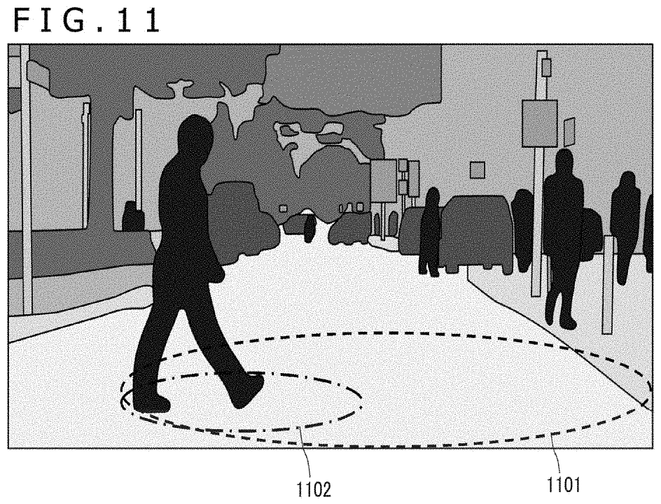

FIG. 11 depicts a moving range 1101 of the pedestrian A estimated by the object moving range estimation unit 807 on the basis of the history information and the prediction information associated with the ground contact surface of the pedestrian A. Moreover, this figure also depicts a moving range 1102 of the pedestrian A estimated on the basis of speed information associated with the pedestrian A.

As described above, the object moving track prediction unit 808 predicts a moving track where the pedestrian A walking while crossing the driveway reaches the sidewalk on the opposite side (walking direction) in the future, and also the object contact region prediction unit 809 predicts the sidewalk as a future contact region of the pedestrian A. The object moving range estimation unit 806 estimates the moving range 1101 of the pedestrian A as a wide range (extending wide toward the sidewalk) on the basis of a result of prediction of the moving track and the contact region, predicting that there is a possibility of future contact between the pedestrian A and the sidewalk, and on the basis of prediction that the pedestrian A is highly likely to accelerate until an arrival at the sidewalk. It is also considered that the object moving range estimation unit 807 can estimate a wider moving range by adding prediction information to history information. On the other hand, the moving range 1102 of the pedestrian A estimated on the basis of the speed information is a moving range of the pedestrian derived from a walking speed vector of the pedestrian A estimated on the basis of position information (i.e., moving track information and prediction information associated with the pedestrian A) in a right column of the contact region time-series information depicted in FIG. 10. In this case, a direction and an area of this moving range are limited.

Accordingly, estimation of the moving range of the pedestrian A by using the information processing system 800 offers such an advantageous effect that a danger of running out of the pedestrian A as a result of acceleration in the middle of crossing the driveway is detectable in an early stage.

The measuring unit 810 measures a steering angle and a vehicle speed of the own vehicle. The danger level determination unit 811 predicts a future reaching range of the own vehicle on the basis of the vehicle control information associated with the own vehicle such as a steering angle and a vehicle speed, searches for an intersection of the predicted future reaching range and the estimated moving range 1101 (described above) of the pedestrian A, and determines that there is a danger of a collision between the pedestrian A and the own vehicle in a case where an intersection has been detected. Thereafter, in a case where the danger level determination unit 811 determines that there is a danger of a collision between the pedestrian A and the own vehicle, the drive assist control unit 812 plans an action of the own vehicle for avoiding a collision between the own vehicle and the pedestrian A, and supplies data indicating the planned action of the own vehicle to the acceleration/deceleration control unit 172 and the direction control unit 173 to achieve damage reduction braking. Moreover, the drive assist control unit 812 may also be configured to give warning, such as output of audio data containing a warning sound, a warning message, or the like from the output unit 106, as well as damage reduction braking.

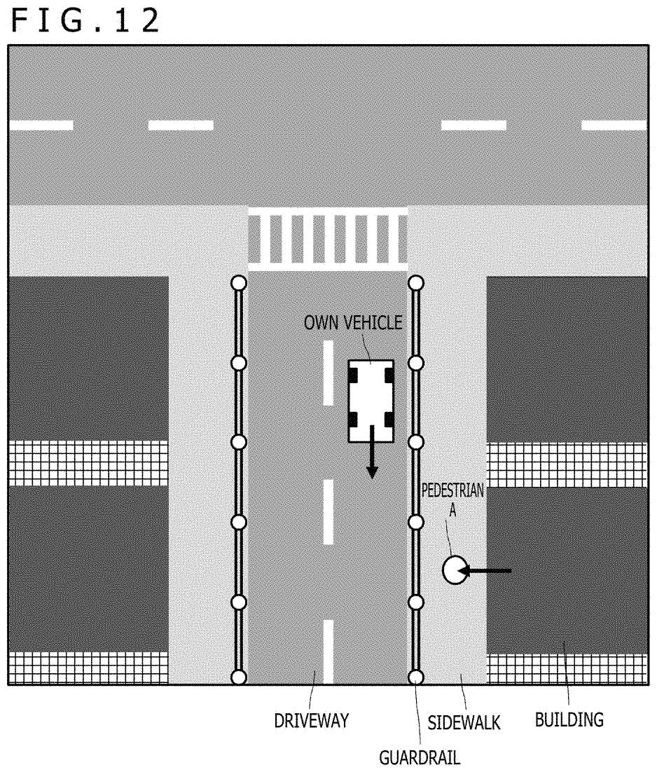

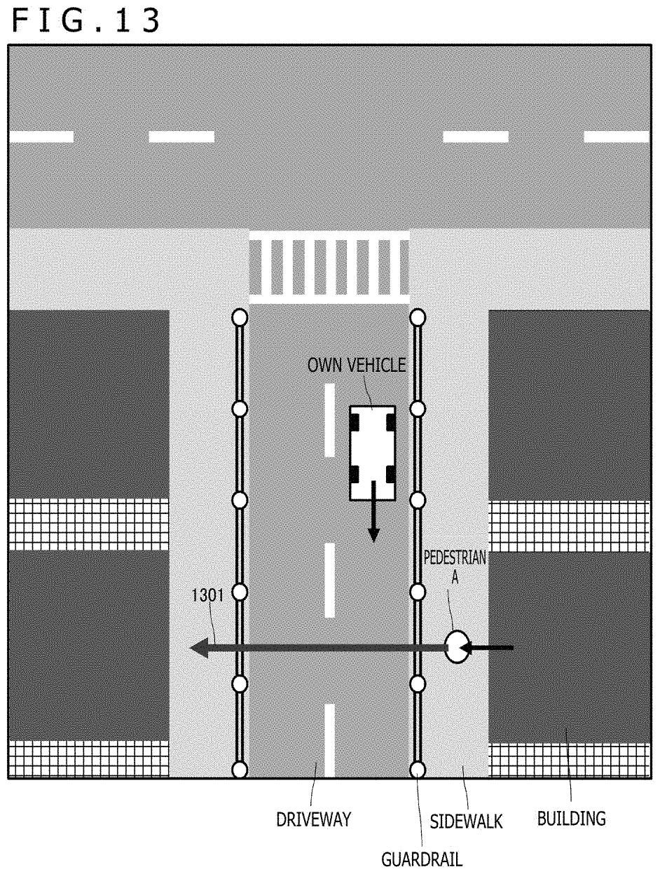

Described next will be another operation example of the information processing system 800 performed in a case where another image is input to the image input unit 801. FIG. 12 depicts meaning information obtained as a result of processing an input image assumed in this operation example by using the image region estimation unit 802, and projected in a bird's eye view direction. In addition, it is assumed that the pedestrian A coming from a building toward a sidewalk is an object. Moreover, according to the example of the bird's eye view map depicted in FIG. 12, contact regions (ground contact surfaces) of the pedestrian A include the building, the sidewalk, a guardrail, a driveway, and others.

The contact region determination unit 804 determines a contact region of each of the objects by using an estimation result obtained by the image region estimation unit 802 on the basis of a tracking result of the objects obtained by the tracking unit 803. Specifically, the contact region determination unit 804 determines which of the building, the sidewalk, the guardrail, the driveway, and others is a ground contact surface of the pedestrian A. Information associated with the ground contact surface is information indicating a label given to a pixel in a contact region of the feet of the pedestrian A. According to the regional image depicted in FIG. 12, it is determined that the ground contact surface of the pedestrian A is determined in an order of the building and the sidewalk. Thereafter, the contact region time-series information storage unit 806 stores time-series information associated with the contact region of the pedestrian A and determined by the contact region determination unit 804. The time-series information associated with the contact region of the pedestrian A includes information indicating a category of the ground contact surface of the pedestrian A and obtained for every predetermined time.

In addition, the moving track information storage unit 805 stores information associated with a moving track of the pedestrian A and extracted by the tracking unit 803 from the regional image. The information associated with the moving track includes position information associated with the pedestrian A and obtained for each predetermined interval.

On the other hand, the object moving track prediction unit 808 predicts a future moving track of the pedestrian A on the basis of moving track information associated with the pedestrian A and stored in the moving track information storage unit 805. Moreover, the object contact region prediction unit 809 predicts a contact region sequentially coming into contact on the future moving track of the pedestrian A predicted by the object moving track prediction unit 808 on the basis of the estimation result obtained by the image region estimation unit 802.

FIG. 13 depicts a result of prediction of the moving track and the contact region of the pedestrian A for the bird's eye view map depicted in FIG. 12. Predicted in the example depicted in FIG. 13 is a moving track 1301 where the pedestrian A coming from the building to the sidewalk will continue to walk while crossing the driveway and reach the opposite sidewalk in the future. Moreover, the sidewalk and the driveway are separated from each other by the guardrail. Accordingly, predicted is a moving track where the pedestrian A will skip over the guardrail, and also predicted are time series of a contact region containing the guardrail for each of positions between the sidewalk and the driveway and between the driveway and the opposite sidewalk.

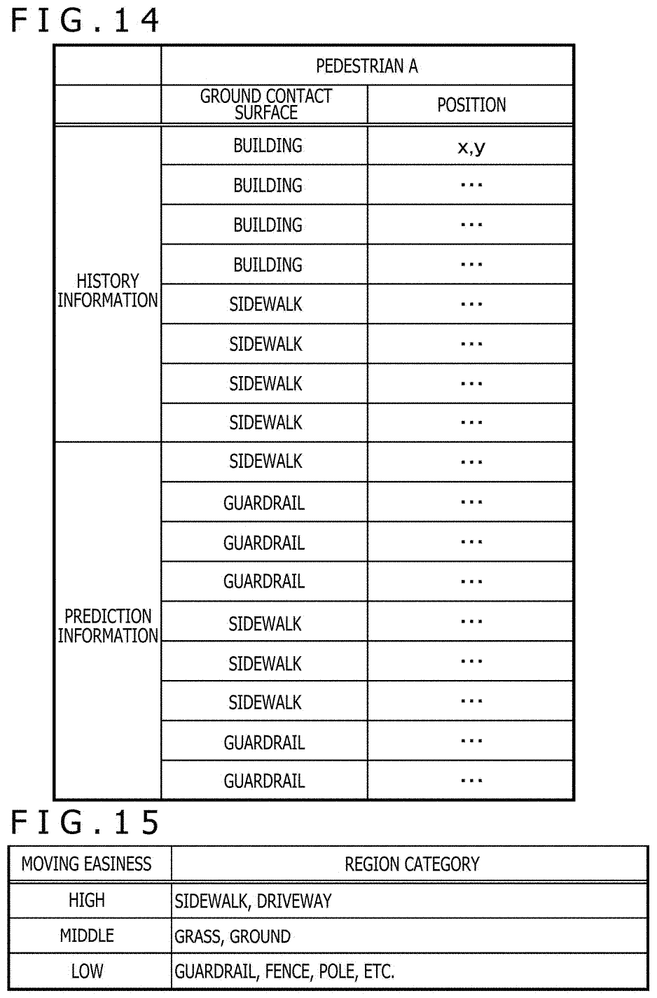

History information indicating a history of the ground contact surface of the pedestrian A as depicted in an upper half of FIG. 14 can be created on the basis of the time-series information associated with a contact region of the pedestrian A and read from the contact region time-series information storage unit 806, and the moving track information associated with the pedestrian A and read from the moving track information storage unit 805.

Moreover, prediction information associated with the ground contact surface of the pedestrian A as depicted in a lower half of the FIG. 14 can be created on the basis of a future moving track of the pedestrian A predicted by the object moving track prediction unit 808, and a future contact region of the pedestrian A predicted by the object contact region prediction unit 809. According to the example depicted in FIG. 14, predicted is a moving track where the pedestrian A will walk to the opposite sidewalk in the future, and also predicted is a future contact region of the pedestrian A when the pedestrian A will skip over the guardrail to move from the sidewalk to the driveway, continue to walk on the driveway for a while, and again skip over the guardrail to come into the opposite sidewalk. It is also predictable on the basis of semantics of the contact region that a time is required to skip over the guardrail (i.e., the moving speed at the guardrail is lower than that at the sidewalk or the driveway).

Each of the history information and the prediction information depicted in FIG. 14 includes a combination of a category of the ground contact surface of the pedestrian A and position information for each predetermined interval. A downward direction in the figure represents a time-axis direction. History information indicating a history of transitions of the pedestrian A on the ground contact surface changing in an order of the building, the building, the building, the building, the sidewalk, the sidewalk, and others is stored. In addition, it is predicted that the pedestrian A will transit on the ground contact surface in an order of the sidewalk, the guardrail, the guardrail, the guardrail, the driveway, the driveway, and others in the future. While FIG. 14 depicts only one prediction pattern, each of the object moving track prediction unit 808 and the object contact region prediction unit 809 may predict plural prediction patterns.

The object moving range estimation unit 807 estimates the moving range of the pedestrian A on the basis of the history information and the prediction information associated with the ground contact surface of the pedestrian A as depicted in FIG. 14. For example, the object moving range estimation unit 807 estimates the moving range of each of the objects on the basis of rules. The rules may be rules described on the basis of semantics of a region in contact with or in ground contact with the object. Moreover, at the time of estimation of the moving range of the object on the basis of rules, a moving track of the object (speed information based on the moving track) or time-series information associated with the contact region is used as a correction coefficient. Further, the object moving range estimation unit 807 may estimate the moving range of each of the objects by machine learning. The machine learning uses a neural network. In a case of machine learning of time-series information associated with the contact region or the like, RNN may be used.

The object moving range estimation unit 807 may set a level of moving easiness for a label of each of the contact regions at the time of estimation of the moving range. The level of moving easiness may be set on the basis of semantics of each region, or on the basis of experimental rules of a system designer or an analysis result. Alternatively, the level of moving easiness may be set on the basis of learning (Deep Learning: DL) using DNN (Deep Neural Network). FIG. 15 depicts a setting example of moving easiness set for each contact region.

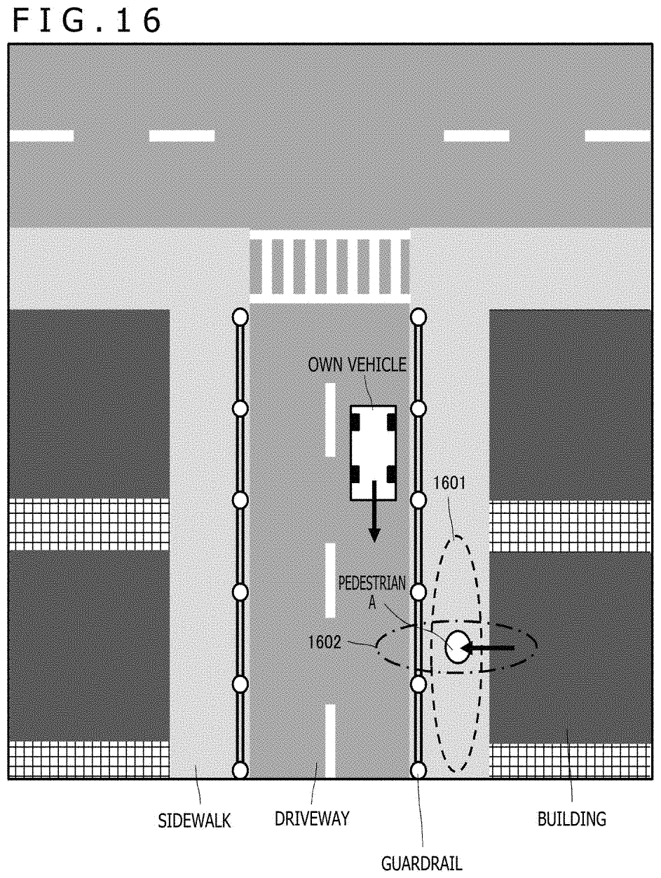

FIG. 16 depicts a moving range 1601 of the pedestrian A estimated by the object moving range estimation unit 807 on the basis of the history information and the prediction information associated with the ground contact surface of the pedestrian A. Moreover, this figure also depicts a moving range 1602 of the pedestrian A estimated on the basis of speed information associated with the pedestrian A.

On the basis of the speed information associated with the pedestrian A coming from the building to the sidewalk, such a moving range where the pedestrian A skips over the guardrail and moves out to the driveway is estimated as indicated by the reference number 1602. On the other hand, in consideration of the moving easiness set for each contact region as depicted in FIG. 15, the guardrail not easy to skip over is visible in front of the eyes of the pedestrian A having moved from the building to the sidewalk. Accordingly, the object moving range estimation unit 807 can estimate such a moving range where the pedestrian A walks on the sidewalk while changing the walking direction to either the left or the right as indicated by the reference number 1601.

Accordingly, estimation of the moving range of the pedestrian A by using the information processing system 800 offers an advantageous effect that a reasonable moving range containing many easy-to-move contact regions can be estimated while avoiding difficulties for the pedestrian A such as skipping over the guardrail and reducing over-detection of speed information associated with the pedestrian A.

The measuring unit 810 measures a steering angle and a vehicle speed of the own vehicle. The danger level determination unit 811 predicts a future reaching range of the own vehicle on the basis of the vehicle control information associated with the own vehicle such as a steering angle and a vehicle speed, and searches for an intersection of the predicted future reaching range and the estimated moving range 1601 of the pedestrian A. However, on the basis of a fact that no intersection is detected, the danger level determination unit 811 determines that there is no danger of a collision between the own vehicle and the pedestrian A. In this case, therefore, danger reduction braking is not performed by the drive assist control unit 812, and any warning sound or warning message is not output from the output unit 106.

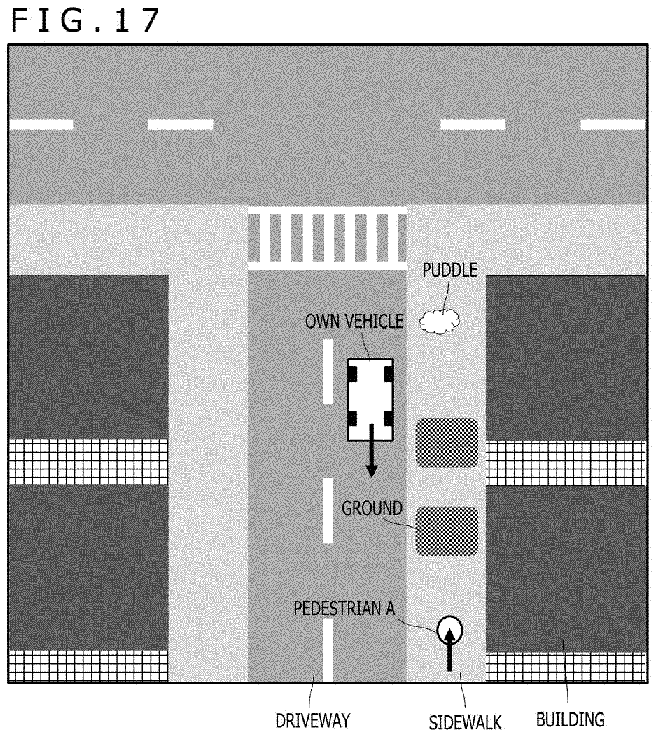

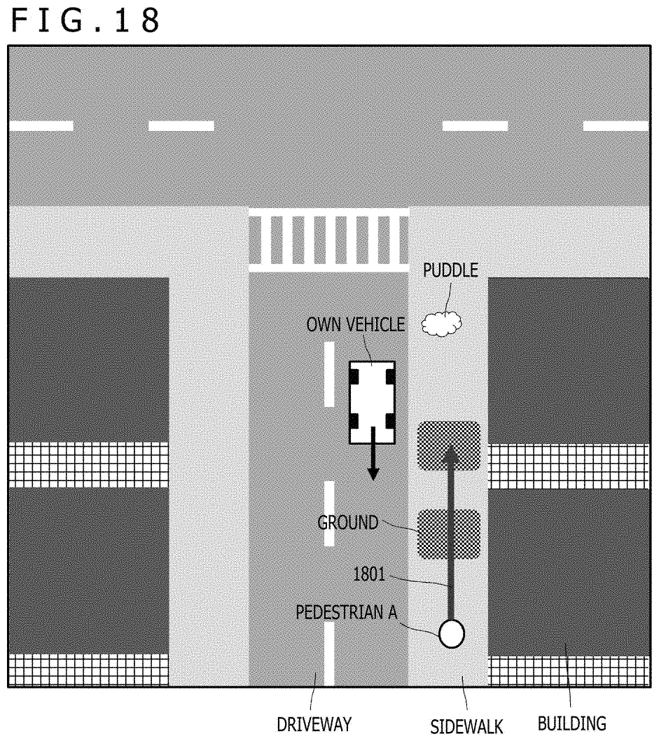

Described next will be a further operation example of the information processing system 800 performed in a case where a further different image is input to the image input unit 801. FIG. 17 depicts meaning information obtained as a result of processing an input image assumed in this operation example by using the image region estimation unit 802, and projected in a bird's eye view direction. In addition, it is assumed that the pedestrian A coming from a building toward a sidewalk is an object. Moreover, according to the example of the bird's eye view map depicted in FIG. 17, contact regions (ground contact surfaces) of the pedestrian A include the building, the sidewalk, a puddle, a ground (e.g., unpaved portion where the ground is exposed in the sidewalk), a driveway, and others.

The contact region determination unit 804 determines a contact region of each of the objects by using an estimation result obtained by the image region estimation unit 802 on the basis of a tracking result of the objects obtained by the tracking unit 803. Specifically, the contact region determination unit 804 determines which of the building, the sidewalk, the puddle, the ground, the driveway, and others is a ground contact surface of the pedestrian A. Information associated with the ground contact surface is information indicating a label given to a pixel in a contact region of the feet of the pedestrian A. Thereafter, the contact region time-series information storage unit 806 stores time-series information associated with the contact region of the pedestrian A and determined by the contact region determination unit 804. The time-series information associated with the contact region of the pedestrian A includes information indicating a category of the ground contact surface of the pedestrian A and obtained for every predetermined time.

In addition, the moving track information storage unit 805 stores information associated with a moving track of the pedestrian A and extracted by the tracking unit 803 from the regional image. The information associated with the moving track includes position information associated with the pedestrian A and obtained for each predetermined interval.

On the other hand, the object moving track prediction unit 808 predicts a future moving track of the pedestrian A on the basis of moving track information associated with the pedestrian A and stored in the moving track information storage unit 805. Moreover, the object contact region prediction unit 809 predicts a contact region sequentially coming into contact on the future moving track of the pedestrian A predicted by the object moving track prediction unit 808 on the basis of the estimation result obtained by the image region estimation unit 802.

FIG. 18 depicts a result of prediction of the moving track and the contact region of the pedestrian A for the bird's eye view map depicted in FIG. 17. According to the example depicted in FIG. 18, it is predicted that the pedestrian A having advanced straight along the sidewalk will follow a moving route 1801 in the future to continuously walk straight on the sidewalk. Moreover, the ground is present in the route of the pedestrian A advancing straight along the sidewalk. Accordingly, it is predicted that a time series of a contact region will contain the ground after the sidewalk.

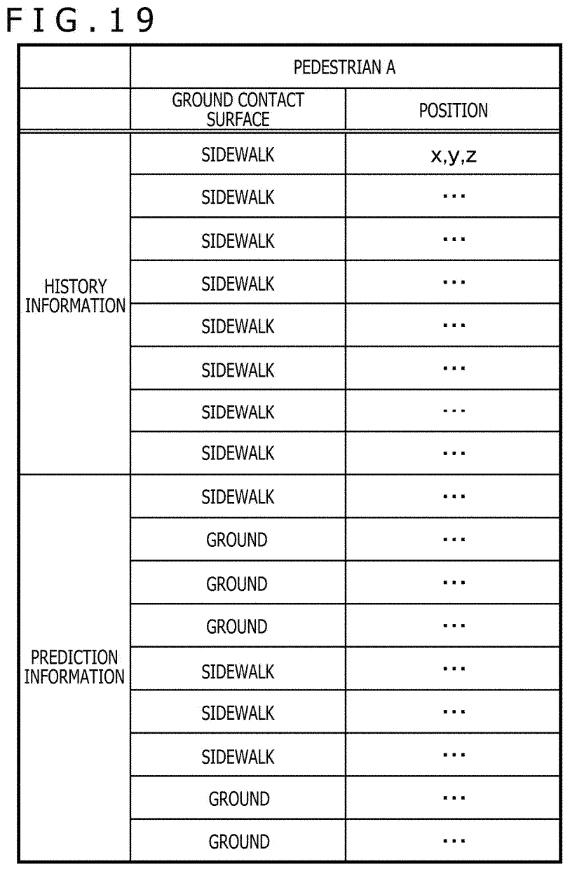

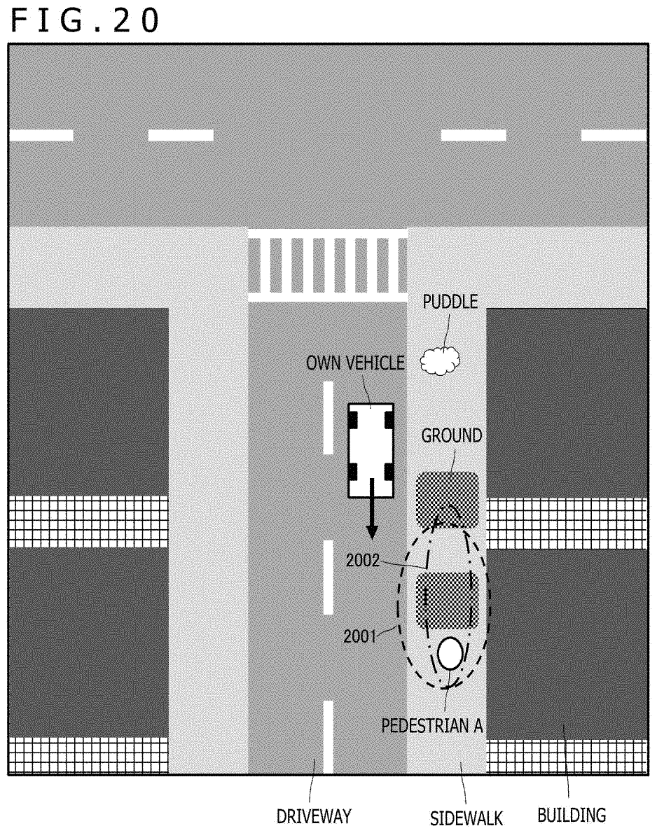

History information indicating a history of the ground contact surface of the pedestrian A as depicted in an upper half of FIG. 19 can be created on the basis of the time-series information associated with a contact region of the pedestrian A and read from the contact region time-series information storage unit 806, and the moving track information associated with the pedestrian A and read from the moving track information storage unit 805.

Moreover, prediction information associated with the ground contact surface of the pedestrian A as depicted in a lower half of the FIG. 19 can be created on the basis of a future moving track of the pedestrian A predicted by the object moving track prediction unit 808, and a future contact region of the pedestrian A predicted by the object contact region prediction unit 809. According to the example depicted in FIG. 19, predicted is a moving track where the pedestrian A will continuously move straight on the sidewalk, and also predicted is a future contact region of the pedestrian A passing through a first ground present on the current route of the pedestrian A.

Each of the history information and the prediction information depicted in FIG. 19 includes a combination of a category of the ground contact surface of the pedestrian A and position information for each predetermined interval. A downward direction in the figure represents a time-axis direction. History information indicating a history of transitions of the pedestrian A on the ground contact surface changing in an order of the sidewalk, the sidewalk, the sidewalk, the sidewalk, the sidewalk, the sidewalk, and others is stored. In addition, it is predicted that the pedestrian A will transit on the ground contact surface in an order of the sidewalk, the ground, the ground, the ground, the sidewalk, the sidewalk, and others in the future. While FIG. 19 depicts only one prediction pattern, each of the object moving track prediction unit 808 and the object contact region prediction unit 809 may predict plural prediction patterns.

The object moving range estimation unit 807 estimates the moving range of the pedestrian A on the basis of the history information and the prediction information associated with the ground contact surface of the pedestrian A as depicted in FIG. 19. For example, the object moving range estimation unit 807 estimates the moving range of each of the objects on the basis of rules. The rules may be rules described on the basis of semantics of a region in contact with or in ground contact with the object. Moreover, at the time of estimation of the moving range of the object on the basis of rules, a moving track of the object (speed information based on the moving track) or time-series information associated with the contact region is used as a correction coefficient. Further, the object moving range estimation unit 807 may estimate the moving range of each of the objects by machine learning. The machine learning uses a neural network. In a case of machine learning of time-series information associated with the contact region or the like, RNN may be used.

The object moving range estimation unit 807 may set a level of moving easiness for a label of each of the contact regions at the time of estimation of the moving range. The level of moving easiness may be set on the basis of semantics of each region, or on the basis of experimental rules of a system designer or an analysis result. Alternatively, the level of moving easiness may be set on the basis of DL using DNN.

FIG. 20 depicts a moving range 2001 of the pedestrian A estimated by the object moving range estimation unit 807 on the basis of the history information and the prediction information associated with the ground contact surface of the pedestrian A. Moreover, this figure also depicts a moving range 2002 of the pedestrian A estimated on the basis of speed information associated with the pedestrian A.

As indicated by the reference number 2002, such a moving range where the pedestrian A walks on the ground is estimated on the basis of speed information associated with the pedestrian A moving straight on the sidewalk. On the other hand, considering a level of moving easiness set for each contact region, such as a case where walking is easier on a paved portion than on an unpaved portion, and a case where shoes having stepped on the ground get dirty, the object moving range estimation unit 807 can estimate that the pedestrian A will walk along such a moving route for moving out to the driveway to avoid the ground as indicated by the reference number 2001 when the ground appears in front of the eyes of the pedestrian A having walked straight along the sidewalk.

Accordingly, estimation of the moving range of the pedestrian A by using the information processing system 800 offers such an advantageous effect as to estimate the practical moving range 2001 containing many contact regions for achieving easy walking and avoiding shoes dirt while allowing reduction of over-detection of speed information associated with the pedestrian A and prevention of contact between the ground or the puddle and the pedestrian A.

The measuring unit 810 measures a steering angle and a vehicle speed of the own vehicle. The danger level determination unit 811 predicts a future reaching range of the own vehicle on the basis of the vehicle control information associated with the own vehicle such as a steering angle and a vehicle speed, and searches for an intersection of the predicted future reaching range and the estimated moving range 2001 of the pedestrian A. In this case, an intersection with a portion out of the sidewalk in the estimated moving range 2001 is found. Accordingly, the danger level determination unit 811 determines that there is a danger of a collision between the pedestrian A and the own vehicle. Thereafter, the drive assist control unit 812 plans an action of the own vehicle for avoiding a collision between the own vehicle and the pedestrian A moving out of the sidewalk, and supplies data indicating the planned action of the own vehicle to the acceleration/deceleration control unit 172 and the direction control unit 173 to achieve damage reduction braking. Moreover, the drive assist control unit 812 may also be configured to give warning, such as output of audio data containing a warning sound, a warning message, or the like from the output unit 106, as well as damage reduction braking.

In addition, description of an operation example of the information processing system 800 performed when the pedestrian A further advances on the sidewalk in the situation depicted in the bird's eye view map of FIG. 17 will be further continued.

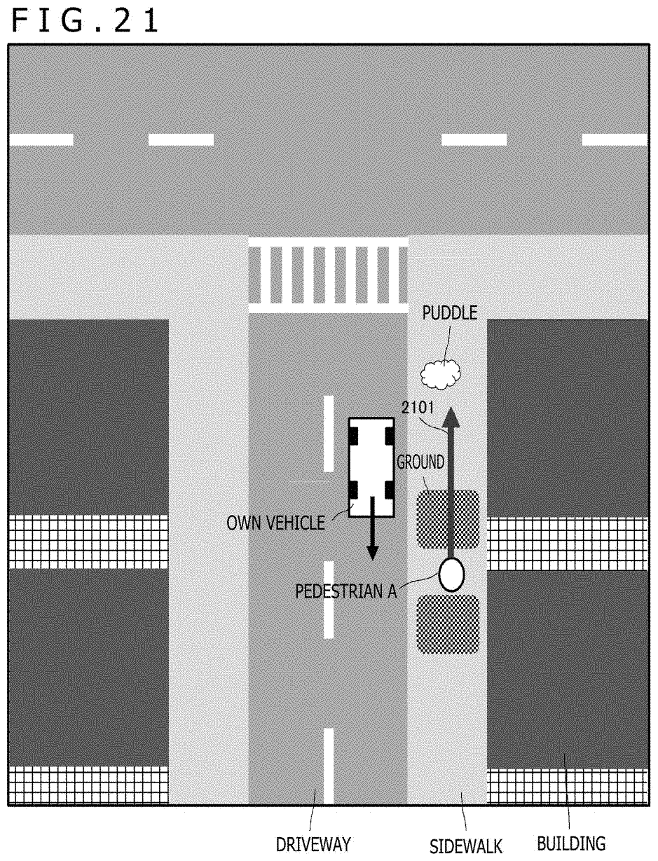

FIG. 21 depicts a result of prediction of the moving track and the contact region of the pedestrian A having passed through the front ground. According to the example depicted in FIG. 21, it is predicted that the pedestrian A moving straight along the sidewalk will follow a moving route 2101 in the future to continuously walk straight on the sidewalk. Moreover, the ground is present in the route of the pedestrian A moving straight along the sidewalk. Accordingly, it is predicted that a time series of a contact region will contain the ground after the sidewalk.

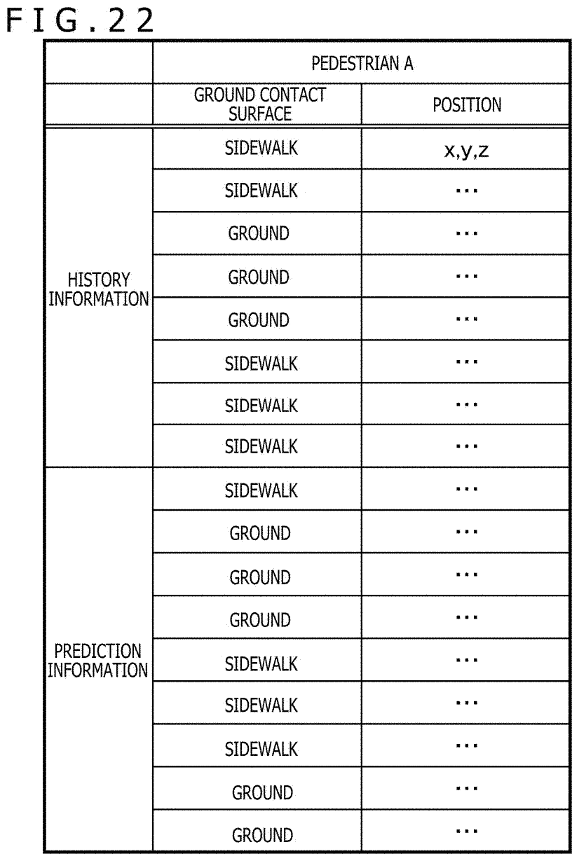

History information indicating a history of the ground contact surface of the pedestrian A as depicted in an upper half of FIG. 22 can be created on the basis of the time-series information associated with a contact region of the pedestrian A and read from the contact region time-series information storage unit 806, and the moving track information associated with the pedestrian A and read from the moving track information storage unit 805.

Moreover, prediction information associated with the ground contact surface of the pedestrian A as depicted in a lower half of FIG. 22 can be created on the basis of a future moving track of the pedestrian A predicted by the object moving track prediction unit 808, and a future contact region of the pedestrian A predicted by the object contact region prediction unit 809. According to the example depicted in FIG. 22, predicted is a moving track where the pedestrian A will continuously move straight on the sidewalk, and also predicted is a future contact region of the pedestrian A passing through a second ground present on the current route of the pedestrian A.

Each of the history information and the prediction information depicted in FIG. 22 includes a combination of a category of the ground contact surface of the pedestrian A and position information for each predetermined interval. A downward direction in the figure represents a time-axis direction. History information indicating a history of transitions of the pedestrian A on the ground contact surface changing in an order of the sidewalk, the ground, the ground, the ground, the sidewalk, the sidewalk, and others is stored. In addition, it is predicted that the pedestrian A will transit on the ground contact surface changing in an order of the sidewalk, the ground, the ground, the ground, the sidewalk, the sidewalk, and others in the future. While FIG. 22 depicts only one prediction pattern, each of the object moving track prediction unit 808 and the object contact region prediction unit 809 may predict plural prediction patterns.

The object moving range estimation unit 807 estimates the moving range of the pedestrian A on the basis of the history information and the prediction information associated with the ground contact surface of the pedestrian A as depicted in FIG. 22. The object moving range estimation unit 807 may set a level of moving easiness for a label of each of the contact regions at the time of estimation of the moving range.

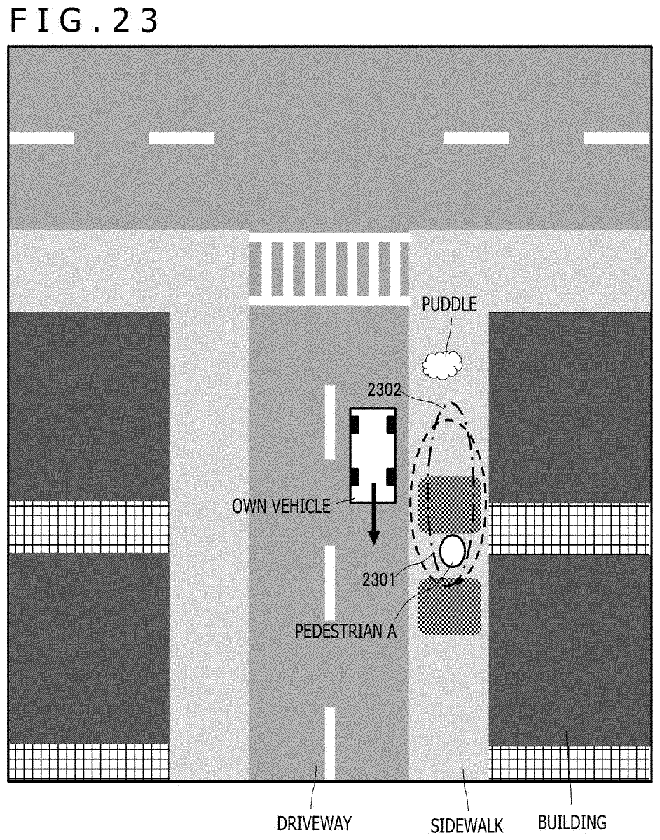

FIG. 23 depicts a moving range 2301 of the pedestrian A estimated by the object moving range estimation unit 807 on the basis of the history information and the prediction information associated with the ground contact surface of the pedestrian A. Moreover, this figure also depicts a moving range 2302 of the pedestrian A estimated on the basis of speed information associated with the pedestrian A. For example, a moving easiness level is set for each contact region, such as a case where walking is easier on a paved portion than on an unpaved portion, and a case where shoes having stepped on the ground get dirty (described above). However, referring to own time-series information associated with the contact region of the pedestrian A (upper part of FIG. 22), the pedestrian A walks on both the sidewalk and the ground, and does not take an action for avoiding the first ground. There is still a possibility that the pedestrian A avoids the second ground when coming into the second ground from the sidewalk. However, with reference to the history, the object moving range estimation unit 807 can estimate that the possibility of avoiding the second ground is low.

Accordingly, estimation of the moving range of the pedestrian A by using the information processing system 800 offers such an advantageous effect as to estimate the reasonable moving range 2301 by predicting a contact region based on a history of the pedestrian A while allowing reduction of over-detection of speed information associated with the pedestrian A.

The measuring unit 810 measures a steering angle and a vehicle speed of the own vehicle. The danger level determination unit 811 predicts a future reaching range of the own vehicle on the basis of the vehicle control information associated with the own vehicle such as a steering angle and a vehicle speed, and searches for an intersection of the predicted future reaching range and the estimated moving range 1601 of the pedestrian A. However, on the basis of a fact that no intersection is detected, the danger level determination unit 811 determines that there is no danger of a collision between the own vehicle and the pedestrian A. In this case, therefore, danger reduction braking is not performed by the drive assist control unit 812, and any warning sound or warning message is not output from the output unit 106.

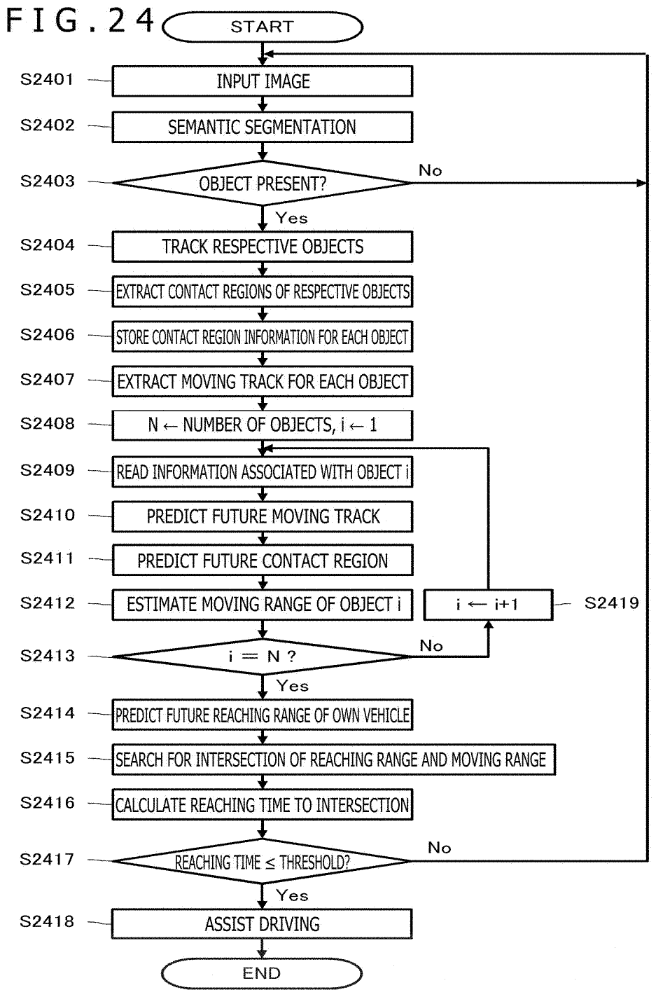

FIG. 24 presents a processing procedure performed by the information processing system 800 in a form of a flowchart.

Initially, the image input unit 801 inputs image information associated with surroundings of the own vehicle, such as an image captured by an in-vehicle camera (step S2401).

Subsequently, the image region estimation unit 802 performs a semantic segmentation process for the input image, and outputs a processing result (step S2402).

Thereafter, the tracking unit 803 checks whether or not an object is present in a regional image obtained by the semantic segmentation process (step S2403). The object referred to herein is a predicted object which may collide with the own vehicle, such as a pedestrian, a bicycle, and a surrounding vehicle.

In a case where no object has been found (No in step S2403), the process returns to step S2401 and inputs a next image.

On the other hand, in a case where objects have been found (Yes in step S2403), the tracking unit 803 extracts information associated with the objects from the regional image obtained by the semantic segmentation process, and tracks respective objects by using the image input in step S2401 or the like (step S2404).

The contact region determination unit 804 extracts information associated with contact regions of the respective objects on the basis of an estimation result obtained by the image region estimation unit 802 and a tracking result of the objects obtained by the tracking unit 803 (step S2405).

Then, the contact region time-series information storage unit 806 stores, for each of the objects, time-series information associated with the contact region of each of the objects and extracted by the contact region determination unit 804 (step S2406).

Moreover, the moving track information storage unit 805 stores, for each of the objects, information associated with a moving track of each of the objects and extracted by the tracking unit 803 (step S2407).

Subsequently, the total number of the objects found in step S2403 is substituted for a variable N, and an initial value 1 is substituted for a variable i which is a count number of the processed objects (step S2408).

Moving history information and contact region time-series information associated with the ith object are read from the moving history information storage unit 805 and the contact region time-series information storage unit 806, respectively (step S2409). Thereafter, the object moving track prediction unit 808 predicts a future moving track of the ith object on the basis of moving track information associated with the ith object (step S2410). Moreover, the object contact region prediction unit 809 predicts a region coming into contact with the ith object in the future on the basis of the future moving track of the ith object predicted by the object moving track prediction unit 808 in step S2401 performed before, and an estimation result of the ith object obtained by the image region estimation unit 802 (step S2411).

Thereafter, the moving history information and the contact region time-series information associated with the ith object are read from the moving history information storage unit 805 and the contact region time-series information storage unit 806, respectively, and a prediction result of the future contact region of the ith object is input from the object contact region prediction unit 809 to estimate a moving range of the ith object by using the object moving range estimation unit 807 (step S2412).

In a case where i is smaller than N, i.e., unprocessed objects still remain herein (No in step S2413), i is incremented only by 1 (step S2419). Then, the process returns to step S2409 to repeatedly perform an estimation process for estimating a moving range of a next object.

On the other hand, when i reaches N, i.e., in a case where the moving range estimation process has been completed for all of the objects (Yes in step S2413), a danger level determination process is subsequently performed for the respective objects.

Initially, the danger level determination unit 811 predicts a future reaching range of the own vehicle on the basis of vehicle control information associated with the own vehicle, such as a steering angle and a vehicle speed (step S2414).

Subsequently, the danger level determination unit 811 searches for an intersection of a predicted future reaching range of the own vehicle and the estimated moving range of each of the objects (step S2415).

Thereafter, in a case where an intersection has been detected, the danger level determination unit 811 calculates a time required for the own vehicle to reach this intersection (step S2416).

Then, the danger level determination unit 811 compares a length of the time required for the own vehicle to reach the intersection with a predetermined threshold (step S2417).

In a case where the time required for the own vehicle to reach the intersection is equal to or shorter than the threshold (Yes in step S2417), the danger level determination unit 811 determines that there is a danger of a collision between the own vehicle and the object. In this case, the drive assist control unit 812 assists driving of the own vehicle on the basis of a determination result obtained by the danger level determination unit 811 (step S2418).

The drive assist control unit 812 plans an action of the own vehicle for avoiding a collision with the object determined to possibly collide with the vehicle, and supplies data indicating the planned action of the own vehicle to the acceleration/deceleration control unit 172 and the direction control unit 173 to achieve the damage reduction brake function. Moreover, the output control unit 105 may output warning, such as output of audio data containing a warning sound, a warning message, or the like, from the output unit 106 as well as the damage reduction brake function.

Further, when the time for the own vehicle to reach the intersection is longer than the threshold (No in step S2417), the danger level determination unit 811 determines that there is no danger of a collision between the own vehicle and the object. In this case, the process returns to step S2401 to repeatedly execute tracking of objects, estimation of moving ranges of objects, and the danger level determination process as described above.

### Embodiment 3

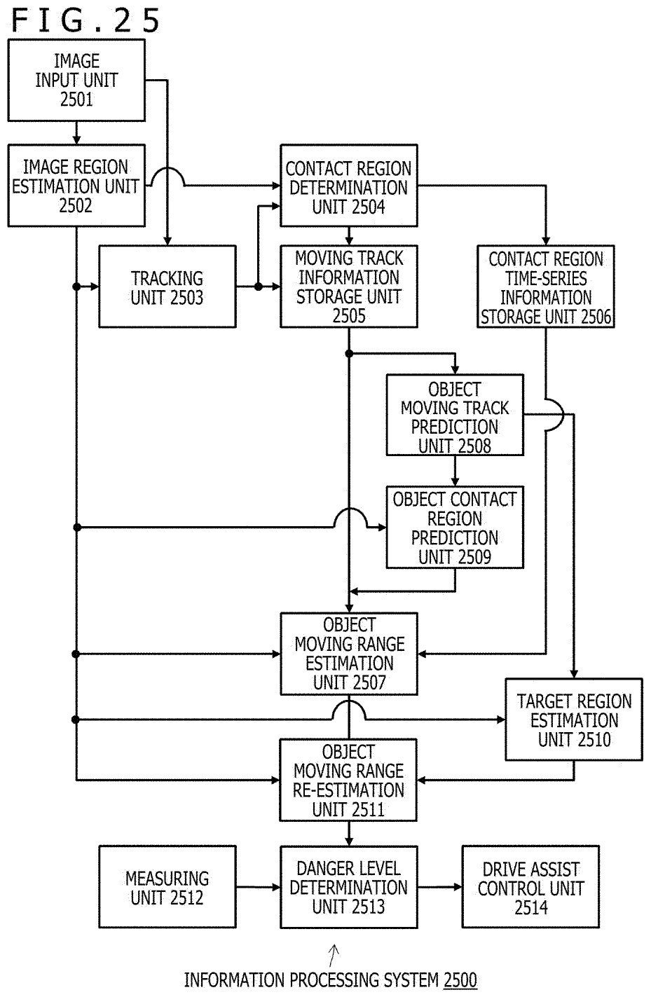

FIG. 25 depicts a functional configuration example of an information processing system 2500 according to a third embodiment. The information processing system 2500 has a function of estimating a moving range of an object such as a pedestrian and a bicycle on the basis of image information associated with surroundings of the own vehicle and captured by an in-vehicle camera, for example. Drive assistance such as warning to the driver, brake assist operation, or control of automatic operation is achievable on the basis of an estimation result obtained by the information processing system 2500.

The information processing system 2500 depicted in the figure includes an image input unit 2501, an image region estimation unit 2502, a tracking unit 2503, a contact region determination unit 2504, a moving track information storage unit 2505, a contact region time-series information storage unit 2506, an object moving range estimation unit 2507, an object moving track prediction unit 2508, an object contact region prediction unit 2509, a target region estimation unit 2510, an object moving range re-estimation unit 2511, a measuring unit 2512, a danger level determination unit 2513, and a drive assist control unit 2514.

At least some of constituent elements of the information processing system 2500 are implemented using constituent elements included in the vehicle control system 100. Moreover, some of the constituent elements of the information processing system 2500 may also be implemented using an information terminal carried into the vehicle interior by the person on board, such as a smartphone and a tablet, or other information apparatuses. In addition, it is assumed that bidirectional data communication between the respective constituent elements of the information processing system 2500 is achievable via a bus or using interprocess communication. The respective constituent elements included in the information processing system 2500 will be hereinafter described.

The image input unit 2501 inputs image information associated with surroundings of the own vehicle, such as an image captured by an in-vehicle camera. However, it is not required to directly input the image information from an image sensor. Three-dimensional shape information obtained by stereoscopy or using a distance sensor such as a TOF sensor and a LiDAR, two-dimensional bird's eye view information obtained by conversion into a two-dimensional bird's eye view figure, equivalent and identical map information, or three-dimensional shape information using time-series measurement information and SLAM or SfM may be used.

The image region estimation unit 2502 estimates respective regions in the image input via the image input unit 2501, by using the semantic segmentation technology, and outputs, for each pixel, information to which a label for identifying a category has been added. Objects are extracted on the basis of an estimation result obtained by the image region estimation unit 2502.

The tracking unit 2503 tracks, using the image input via the image input unit 2501, respective objects extracted on the basis of the estimation result obtained by the image region estimation unit 2502.

The contact region determination unit 2504 determines a contact region of each of the objects by using an estimation result obtained by the image region estimation unit 2502 on the basis of a tracking result of the objects obtained by the tracking unit 2503. For example, it is determined which of a sidewalk, a driveway, and others is a ground contact surface of each of the objects such as a pedestrian and a bicycle.

The moving track information storage unit 2505 stores, for each of the objects, information associated with a moving track of each of the objects and extracted by the tracking unit 2503. Moreover, the contact region time-series information storage unit 2506 stores, for each of the objects, time-series information associated with the contact region of each of the objects and determined by the contact region determination unit 2504.

The object moving track prediction unit 2508 predicts a future moving track of each of the objects on the basis of moving track information associated with each of the objects and stored in the moving track information storage unit 2505. The object moving regulation prediction unit 2508 may predict the moving track of each of the objects by machine learning. The machine learning uses a neural network. For machine learning of time-series information such as a moving track, RNN may be used.

The object contact region prediction unit 2509 predicts a contact region sequentially coming into contact on the future moving track of each of the objects predicted by the object moving track prediction unit 2508 on the basis of the future moving track of each of the objects predicted by the object moving track prediction unit 2508 and the estimation result obtained by the image region estimation unit 2502. The object contact region prediction unit 2509 may predict the contact region of each of the objects by machine learning. The machine learning uses a neural network.

The object moving range estimation unit 2507 estimates a moving range of each of the objects by using the estimation result obtained by the image region estimation unit 2502 on the basis of information associated with the contact region of the object and stored in the moving track information storage unit 2505, time-series information associated with the contact region of the object and stored in the contact region time-series information storage unit 2506, and further a future moving track predicted by the object moving track prediction unit 2508 and a future contact region predicted by the object contact region prediction unit 2509, and outputs the estimated or predicted moving range of each of the objects. In a case where the time-series information associated with the contact region of each of the objects contains speed information associated with the object, the object moving range estimation unit 2507 may estimate the moving range in consideration of the speed information associated with the object.

For example, the object moving range estimation unit 2507 estimates the moving range of each of the objects on the basis of rules. Moreover, at the time of estimation of the moving range of the object on the basis of rules, a moving track of the object (speed information based on the moving track) or time-series information associated with the contact region is used as a correction coefficient for linear prediction. Further, the object moving range estimation unit 2507 may estimate the moving range of each of the objects by machine learning. The machine learning uses a neural network. In a case of machine learning of time-series information associated with the contact region or the like, RNN may be used.

The target region estimation unit 2510 estimates a target region corresponding to a movement target of the object on the basis of the future moving track of the object predicted by the object moving track prediction unit 2508. For example, in a case where the predicted moving track for a pedestrian trying to move from the sidewalk and walk on the driveway is directed toward the opposite sidewalk, the target region estimation unit 2510 estimates the opposite sidewalk as a target region corresponding to the movement target on the basis of the estimation result of the image region estimation unit 2502.

The object moving range re-estimation unit 2511 further re-estimates the moving range of the object estimated by the object moving range estimation unit 2507 in consideration of the target region of the object estimated by the target region estimation unit 2510. For example, when presence of an obstacle is detected within the moving range estimated by the object moving range estimation unit 2507 on the basis of the estimation result of the image region estimation unit 2502, the object moving range re-estimation unit 2511 re-estimates a moving range where the object is allowed to reach the target region estimated by the target region estimation unit 2510. For example, the moving range thus re-estimated contains a route along which the object is allowed to reach the target region while avoiding the obstacle.

The measuring unit 2512 measure a steering angle and a vehicle speed of the own vehicle. The measuring unit 2512 may be the data acquisition unit 102 (described above) in the vehicle control system 100. Alternatively, the measuring unit 2512 may be replaced with a function module which inputs vehicle control information such as a steering angle and a vehicle speed from the vehicle control system 100.

The danger level determination unit 2513 determines, for each of the objects, a danger level of a collision with the own vehicle on the basis of a comparison result between the moving range of each of the objects estimated by the object moving range re-estimation unit 2511 and the vehicle control information associated with the own vehicle such as a steering angle and a vehicle speed. Specifically, the danger level determination unit 2513 predicts a future reaching range of the own vehicle on the basis of the vehicle control information associated with the own vehicle such as a steering angle and a vehicle speed, and searches for an intersection of the predicted future reaching range and the estimated moving range of each of the objects to determine that there is a danger of a collision between the own vehicle and the object for which an intersection has been found.

The drive assist control unit 2514 assists driving of the own vehicle on the basis of a determination result obtained by the danger level determination unit 2513. The drive assist control unit 2514 may be the emergency avoidance unit 171 (described above) in the vehicle control system 100. The emergency avoidance unit 171 plans an action of the own vehicle for avoiding a collision with the object determined to possibly collide with the own vehicle, and supplies data indicating the planned action of the own vehicle to the acceleration/deceleration control unit 172 and the direction control unit 173 to achieve the damage reduction brake function. Moreover, the vehicle control system 100 may also be configured such that the output control unit 105 gives warning, such as output of audio data containing a warning sound, a warning message, or the like from the output unit 106, as well as the damage reduction brake function.

A specific operation example of the information processing system 2500 according to the third embodiment will be subsequently described. It is assumed herein that a regional image has been obtained from an image input from the image input unit 2501 by semantic segmentation performed by the image region estimation unit 2502, and that the moving range 1101 of the pedestrian A has been estimated by the object moving range estimation unit 2507 on the basis of history information and prediction information associated with the ground contact surface of the pedestrian A. Described hereinafter will be a process performed by the object moving range re-estimation unit 2511 to further re-estimate the moving range of the object in consideration of the target region of the object estimated by the target region estimation unit 2510.

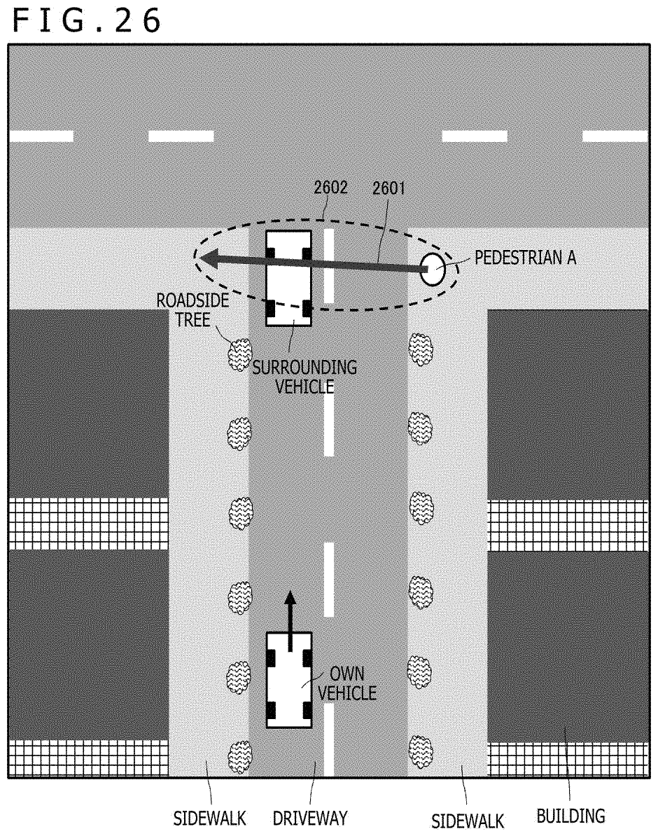

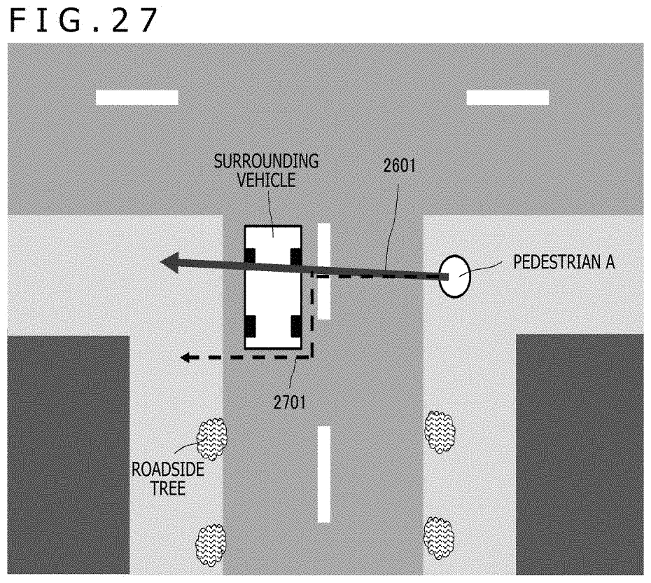

FIG. 26 depicts meaning information obtained as a result of processing an input image assumed in this operation example by using the image region estimation unit 2502, and projected in a bird's eye view direction. In this figure, a track denoted by a reference number 2601 indicates a future moving track of the pedestrian A predicted by the object moving track prediction unit 2508. Moreover, a range denoted by a reference number 2602 indicates a future moving range of the pedestrian A estimated by the object moving range estimation unit 2507.

The predicted moving track 2601 predicted for the pedestrian A who is trying to move from the sidewalk to the driveway and walk on the driveway is directed toward the opposite sidewalk. Accordingly, the target region estimation unit 2510 estimates that the opposite sidewalk is a target region corresponding to a movement target of the pedestrian A on the basis of an estimation result of the image region estimation unit 2502.

The object moving range re-estimation unit 2511 estimates, on the basis of the estimation result obtained by the image region estimation unit 2502, an obstacle present on the route of the pedestrian A for moving to the target region estimated by the target region estimation unit 2510 within the moving range 2602 of the pedestrian A estimated by the object moving range estimation unit 2507. According to the example depicted in FIG. 26, a surrounding vehicle stopping in front of the own vehicle is an obstacle on the route of the pedestrian A on the moving route of the pedestrian A within the moving range 2602.

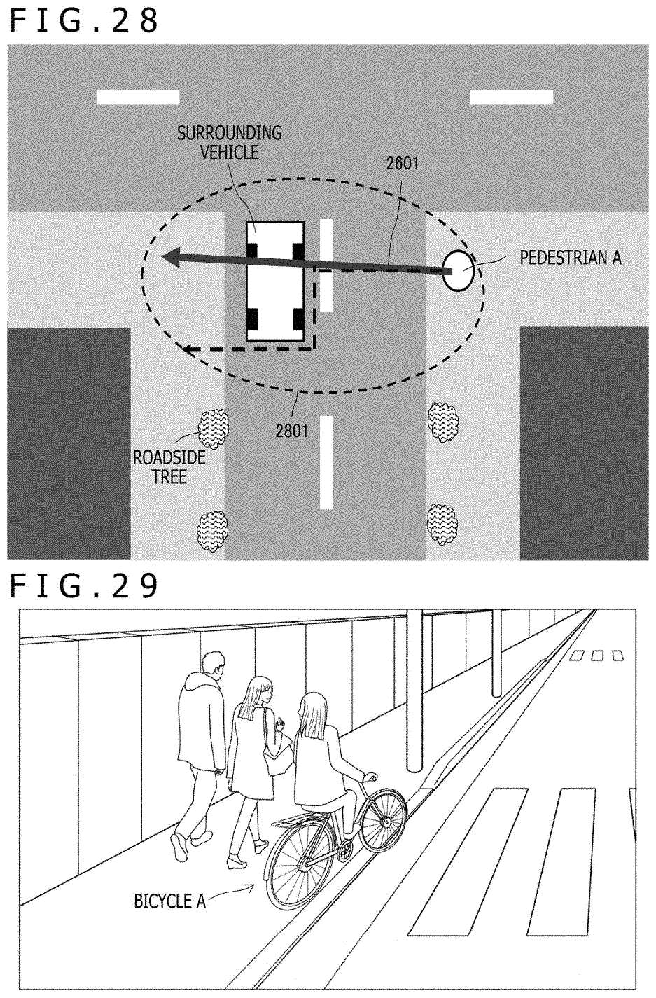

Accordingly, the object moving range re-estimation unit 2511 redesigns, using a route planning method, a route for allowing the pedestrian A to reach the opposite sidewalk corresponding to the target region while avoiding the surrounding vehicle corresponding to the obstacle as indicated by a reference number 2701 in FIG. 27. Thereafter, the object moving range re-estimation unit 2511 re-estimates a moving range containing the route 2701 that is redesigned to allow the pedestrian A to reach the target region, as indicated by a reference number 2801 in FIG. 28.

The measuring unit 2512 measures a steering angle and a vehicle speed of the own vehicle. The danger level determination unit 2513 predicts a future reaching range of the own vehicle on the basis of the vehicle control information associated with the own vehicle such as a steering angle and a vehicle speed, and searches for an intersection of the predicted future reaching range and the estimated moving range 2801 of the pedestrian A. In a case where an intersection of the predicted future reaching range of the own vehicle and the estimated moving range 2801 has been found, the danger level determination unit 2513 determines that there is a danger of a collision between the pedestrian A and the own vehicle. In this case, the drive assist control unit 2514 plans an action of the own vehicle for avoiding a collision between the own vehicle and the pedestrian A moving out of the sidewalk, and supplies data indicating the planned action of the own vehicle to the acceleration/deceleration control unit 172 and the direction control unit 173 to achieve damage reduction braking. Moreover, the drive assist control unit 2514 may also be configured to give a warning, such as output of audio data containing a warning sound, a warning message, or the like from the output unit 106, as well as damage reduction braking.

Another specific operation example of the information processing system 2500 according to the third embodiment will be subsequently described. It is assumed herein that an image captured by an in-vehicle camera and depicted in FIG. 29 has been input from the image input unit 2501. Described will be a process for estimating and re-estimating a moving range by using the information processing system 2500 on an assumption that one person riding a bicycle (hereinafter simply referred to as a “bicycle A”) is an object in the input image which contains two persons walking side by side on the sidewalk and the one person riding the bicycle.

The contact region determination unit 2504 determines a contact region of the bicycle A by using an estimation result obtained by the image region estimation unit 2502 on the basis of a tracking result of the object obtained by the tracking unit 2503. Thereafter, the contact region time-series information storage unit 2506 stores time-series information associated with the contact region of the bicycle A and determined by the contact region determination unit 2504. The time-series information associated with the contact region of the bicycle A includes category information indicating the ground contact surface of the bicycle A and obtained for every predetermined time. In addition, the moving track information storage unit 2505 stores information associated with a moving track of the bicycle A and extracted by the tracking unit 2503 from the estimation result obtained by the image region estimation unit 2502. The information associated with the moving track includes position information associated with the bicycle A and obtained for each predetermined interval.

On the other hand, the object moving track prediction unit 2508 predicts a future moving track of the bicycle A on the basis of moving track information associated with the bicycle A and stored in the moving track information storage unit 2505. Moreover, the object contact region prediction unit 2509 predicts a contact region sequentially coming into contact on the future moving track of the bicycle A predicted by the object moving track prediction unit 2508 on the basis of the estimation result obtained by the image region estimation unit 2502.

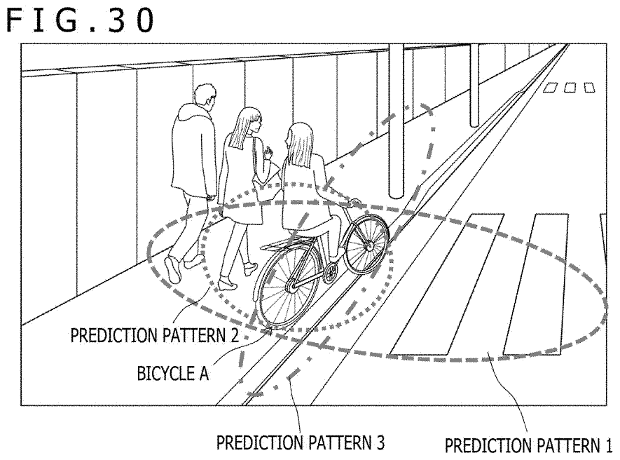

FIG. 30 depicts an example of a result of prediction of a future moving track and a future contact region of the bicycle A for the input image depicted in FIG. 29. A prediction result of three patterns is presented in the example depicted in FIG. 30. Predicted in prediction pattern 1 is such a moving track and a contact region where the bicycle A will part from the other two persons, cross a crosswalk, and move toward the opposite sidewalk at the time of arrival at a crosswalk. Moreover, predicted in prediction pattern 2 is such a moving track and a contact region where the bicycle A will continue to move forward on the sidewalk together with the other two persons on the basis of a history of speed information. Further, predicted in prediction pattern 3 is such a moving track and a contact region where the bicycle A will start to pedal the bicycle and advance on the sidewalk before the other two persons.

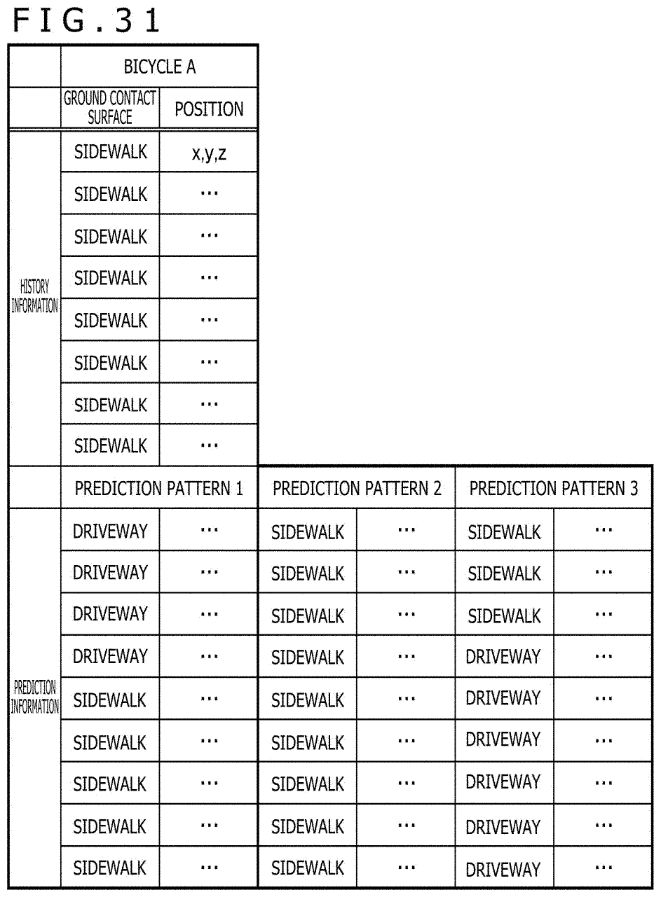

History information indicating a history of the ground contact surface of the bicycle A as depicted in an upper half of FIG. 31 can be created on the basis of the time-series information associated with a contact region of the bicycle A and read from the contact region time-series information storage unit 2506, and the moving track information associated with the bicycle A and read from the moving track information storage unit 2505. Moreover, prediction information associated with the ground contact surface of the bicycle A as depicted in a lower half of the FIG. 31 can be created on the basis of a future moving track of the bicycle A predicted by the object moving track prediction unit 2508, and a future contact region of the bicycle A predicted by the object contact region prediction unit 2509.

Each of the history information and the prediction information depicted in FIG. 31 includes a combination of a category of the ground contact surface of the bicycle A and position information for each predetermined interval. A downward direction in the figure represents a time-axis direction. History information indicating a history of transitions of the pedestrian A on the ground contact surface changing in an order of the sidewalk, the sidewalk, the sidewalk, the sidewalk, the sidewalk, the sidewalk, and others is stored.

Moreover, a prediction result of the above three patterns is presented in the example depicted in FIG. 31. It is predicted in prediction pattern 1 that the bicycle A will transit on the ground contact surface in the future in an order of the driveway, the driveway, the driveway, the driveway, the sidewalk, the sidewalk, and others. It is also predicted in prediction pattern 2 that the bicycle A will transit on the ground contact surface in the future in an order of the sidewalk, the sidewalk, the sidewalk, the sidewalk, the sidewalk, the sidewalk, and others. It is further predicted in prediction pattern 3 that the bicycle A will transit on the ground contact surface in the future in an order of the sidewalk, the sidewalk, the sidewalk, the driveway, the driveway, the driveway, the driveway, and others.

The target region estimation unit 2510 estimates a target region of the bicycle A for each prediction pattern on the basis of an estimation result obtained by the image region estimation unit 2502.

Moreover, the object moving range re-estimation unit 2511 estimates, on the basis of the estimation result obtained by the image region estimation unit 2502, an obstacle present on the route of the bicycle A for moving to the target region estimated by the target region estimation unit 2510 for each prediction pattern.

Thereafter, the object moving range re-estimation unit 2511 redesigns a route allowing the bicycle A to reach the target region while avoiding the obstacle for each prediction pattern by a route planning method to re-estimate a moving range of the bicycle A for covering routes redesigned for all the prediction patterns.

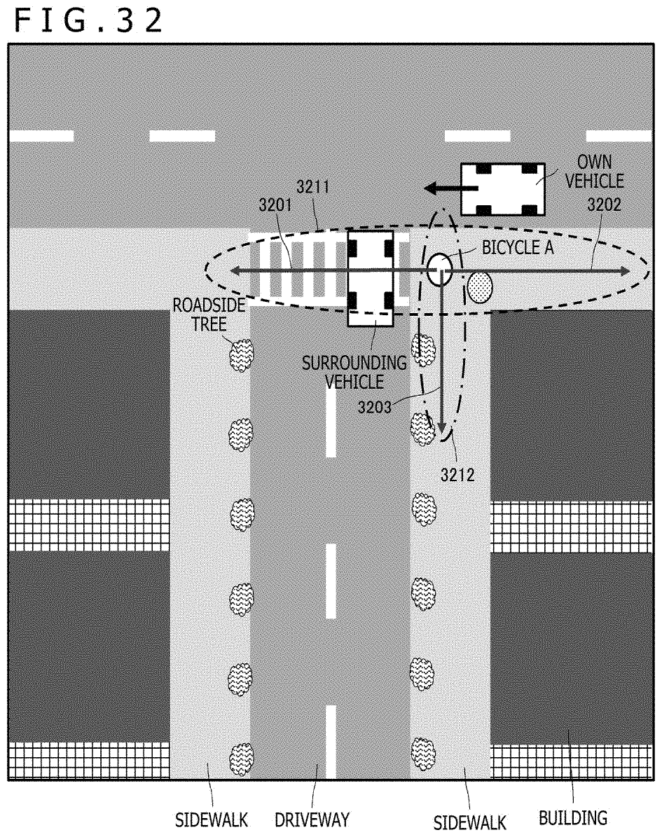

Further described will be another specific example of the process for estimating and re-estimating a moving range by using the information processing system 2500. It is assumed herein that a processing result of semantic segmentation performed by the image region estimation unit 2502 coincides with a case depicted in FIG. 32, and that the bicycle A near a junction is an object. It is assumed in FIG. 32 that three patterns of the moving track and the contact region indicated by reference numbers 3201 to 3203 have been predicted on the basis of time-series information associated with the moving track and the contact region of the bicycle A, or of speed information, and that two patterns of the moving range indicated by reference numbers 3211 and 3212 have been estimated by the object moving range estimation unit 2507 on the basis of a result of the prediction.

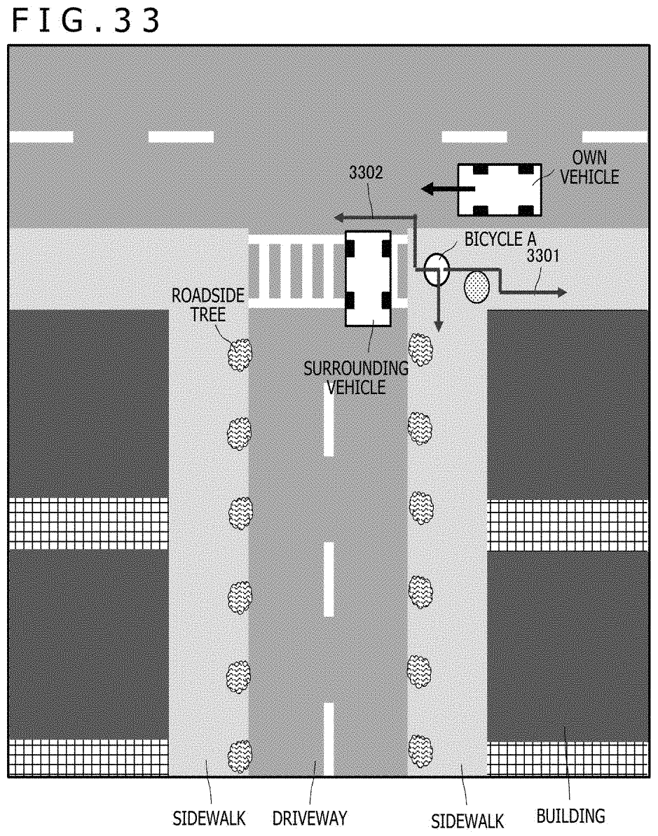

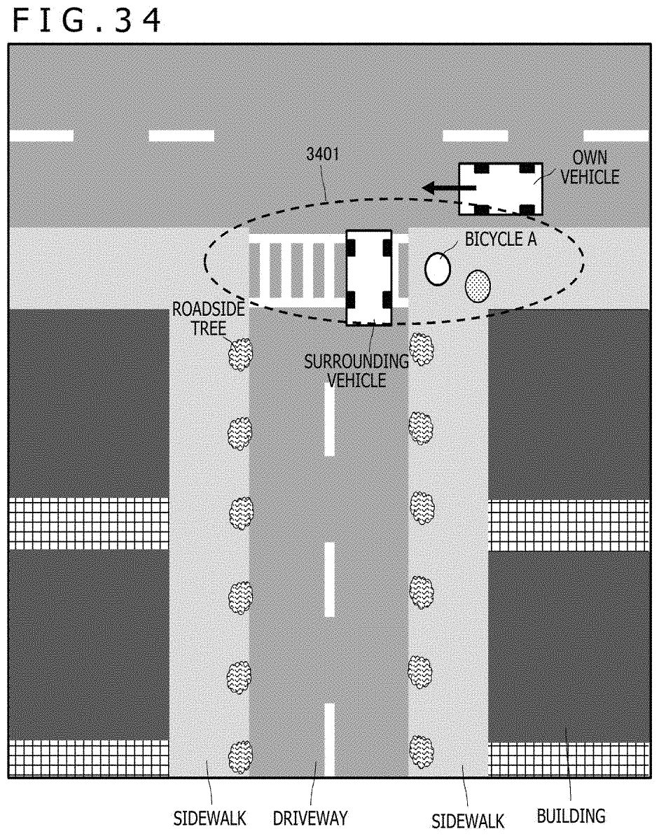

The target region estimation unit 2510 estimates a target region for each of the three patterns including the moving tracks and the contact regions 3201 to 3203 predicted for the bicycle A. The object moving range re-estimation unit 2511 estimates an obstacle present on a route of the bicycle A for moving to the target region for each of the moving tracks and the contact regions 3201 to 3203, and redesigns routes allowing the bicycle A to reach the target region while avoiding the obstacle by using a route planning method. FIG. 33 depicts routes 3301 and 3302 thus redesigned. Thereafter, the object moving range re-estimation unit 2511 re-estimates a moving range of the bicycle A for covering the redesigned routes 3301 and 3302. FIG. 34 depicts a final moving range 3401 of the bicycle A re-estimated by the object moving range re-estimation unit 2511.

The measuring unit 2512 measure a steering angle and a vehicle speed of the own vehicle. The danger level determination unit 2513 predicts a future reaching range of the own vehicle on the basis of the vehicle control information associated with the own vehicle such as a steering angle and a vehicle speed, and searches for an intersection of the predicted future reaching range and the estimated moving range 2801 of the bicycle A. In a case where an intersection of the predicted future reaching range of the own vehicle and the estimated moving range 2801 has been found, the danger level determination unit 2513 determines that there is a danger of a collision between the bicycle A and the own vehicle. In this case, the drive assist control unit 2514 plans an action of the own vehicle for avoiding a collision between the own vehicle and the bicycle A moving out of the sidewalk, and supplies data indicating the planned action of the own vehicle to the acceleration/deceleration control unit 172 and the direction control unit 173 to achieve damage reduction braking. Moreover, the drive assist control unit 2514 may also be configured to give warning, such as output of audio data containing a warning sound, a warning message, or the like from the output unit 106, as well as damage reduction braking.

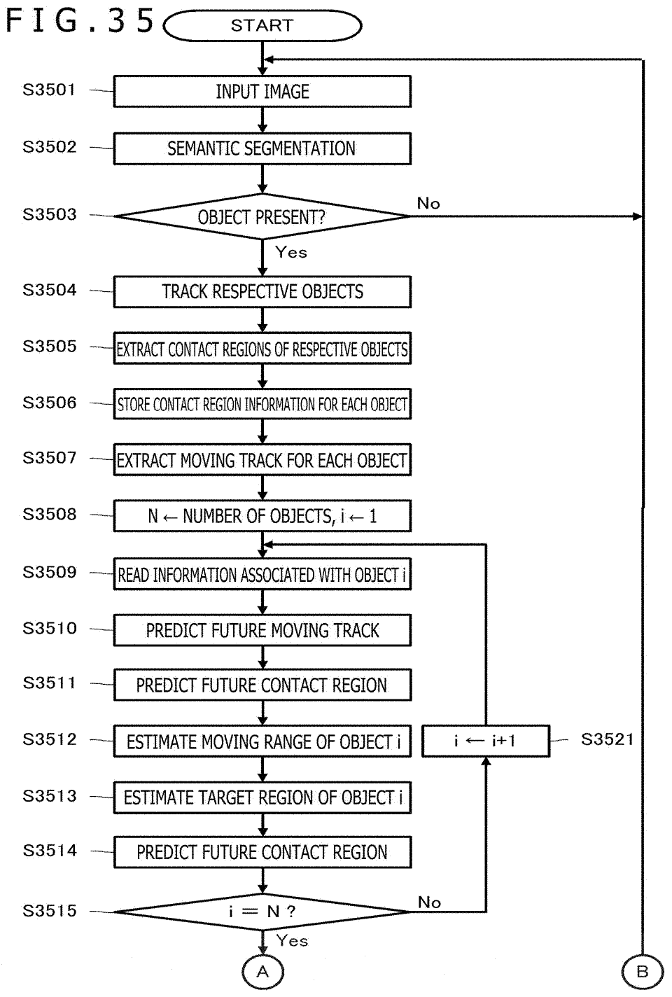

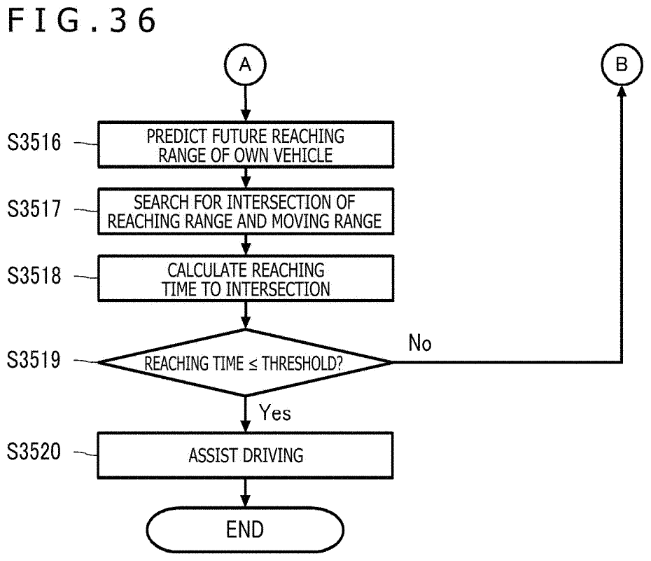

FIGS. 35 and 36 each present a processing procedure performed by the information processing system 2500 in a form of a flowchart. Note that FIG. 35 presents a first half of the processing procedure, and that FIG. 36 presents a second half of the processing procedure.

Initially, the image input unit 2501 inputs image information associated with surroundings of the own vehicle, such as an image captured by an in-vehicle camera (step S3501).

Subsequently, the image region estimation unit 2502 performs a semantic segmentation process for the input image, and outputs a processing result (step S3502).

Thereafter, the tracking unit 2503 checks whether or not an object is present in a regional image obtained by the semantic segmentation process (step S3503). The object referred to herein is a predicted object which may collide with the own vehicle, such as a pedestrian, a bicycle, and a surrounding vehicle.

In a case where no object has been found (No in step S3503), the process returns to step S3501 and inputs a next image.

On the other hand, in a case where objects have been found (Yes in step S3503), the tracking unit 2503 extracts information associated with the objects from the regional image obtained by the semantic segmentation process, and tracks respective objects by using the image input in step S3501 or the like (step S3504).

The contact region determination unit 2504 extracts information associated with contact regions of the respective objects on the basis of an estimation result obtained by the image region estimation unit 2502 and a tracking result of the objects obtained by the tracking unit 2503 (step S3505).

Then, the contact region time-series information storage unit 2506 stores, for each of the objects, time-series information associated with the contact region of each of the objects extracted by the contact region determination unit 2504 (step S3506).

Moreover, the moving track information storage unit 2505 stores, for each of the objects, information associated with a moving track of each of the objects and extracted by the tracking unit 2503 (step S3507).

Subsequently, the total number of the objects found in step S3503 is substituted for a variable N, and an initial value 1 is substituted for a variable i which is a count number of the processed objects (step S3508).

Moving history information and contact region time-series information associated with the ith object are read from the moving history information storage unit 2505 and the contact region time-series information storage unit 2506, respectively (step S3509). Thereafter, the object moving track prediction unit 2508 predicts a future moving track of the ith object on the basis of moving track information associated with the ith object (step S3510). Moreover, the object contact region prediction unit 2509 predicts a region coming into contact with the ith object in the future on the basis of the future moving track of the ith object predicted by the object moving track prediction unit 2508 in step S3501 performed before, and an estimation result of the ith object obtained by the image region estimation unit 2502 (step S3511).

Thereafter, the moving history information and the contact region time-series information associated with the ith object are read from the moving history information storage unit 2505 and the contact region time-series information storage unit 2506, respectively, and a prediction result of the future contact region of the ith object is input from the object contact region prediction unit 2509 to estimate a moving range of the ith object by using the object moving range estimation unit 2507 (step S3512).

Subsequently, the target region estimation unit 2510 estimates a target region corresponding to a target of movement of the ith object on the basis of the estimation result obtained by the image region estimation unit 2502 and the future moving track of the ith object predicted by the object moving track prediction unit 2508 (step S3513).

Thereafter, the object moving range re-estimation unit 2511 further re-estimates the moving range of the ith object estimated by the object moving range estimation unit 2507 in consideration of the target region of the ith object estimated by the target region estimation unit 2510 (step S3514).

In a case where i is smaller than N, i.e., unprocessed objects still remain herein (No in step S3515), i is incremented only by 1 (step S2419). Then, the process returns to step S3509 to repeatedly perform an estimation process for estimating a moving range of a next object.

On the other hand, when i reaches N, i.e., in a case where the moving range estimation process has been completed for all of the objects (Yes in step S3515), a danger level determination process is subsequently performed for each of the objects.

Initially, the danger level determination unit 2513 predicts a future reaching range of the own vehicle on the basis of vehicle control information associated with the own vehicle, such as a steering angle and a vehicle speed (step S3516).

Subsequently, the danger level determination unit 2513 searches for an intersection of the predicted future reaching range of the own vehicle and the estimated moving range of each of the objects (step S3517).

Thereafter, in a case where an intersection has been detected, the danger level determination unit 2513 calculates a time required for the own vehicle to reach this intersection (step S3518).

Then, the danger level determination unit 2513 compares a length of the time required for the own vehicle to reach the intersection with a predetermined threshold (step S3519).

In a case where the time required for the own vehicle to reach the intersection is equal to or shorter than the threshold (Yes in step S3519), the danger level determination unit 2513 determines that there is a danger of a collision between the own vehicle and the object. In this case, the drive assist control unit 2514 assists driving of the own vehicle on the basis of a determination result obtained by the danger level determination unit 2513 (step S3520).

The drive assist control unit 2514 plans an action of the own vehicle for avoiding a collision with the object determined to possibly collide with the vehicle, and supplies data indicating the planned action of the own vehicle to the acceleration/deceleration control unit 172 and the direction control unit 173 to achieve the damage reduction brake function. Moreover, the output control unit 105 may output warning, such as output of audio data containing a warning sound, a warning message, or the like, from the output unit 106 as well as the damage reduction brake function.

Further, when the time required for the own vehicle to reach the intersection is longer than the threshold (No in step S3519), the danger level determination unit 811 determines that there is no danger of a collision between the own vehicle and the object. In this case, the process returns to step S3501 to repeatedly execute tracking of objects, estimation of moving ranges of objects, and the danger level determination process as described above.

### Embodiment 4

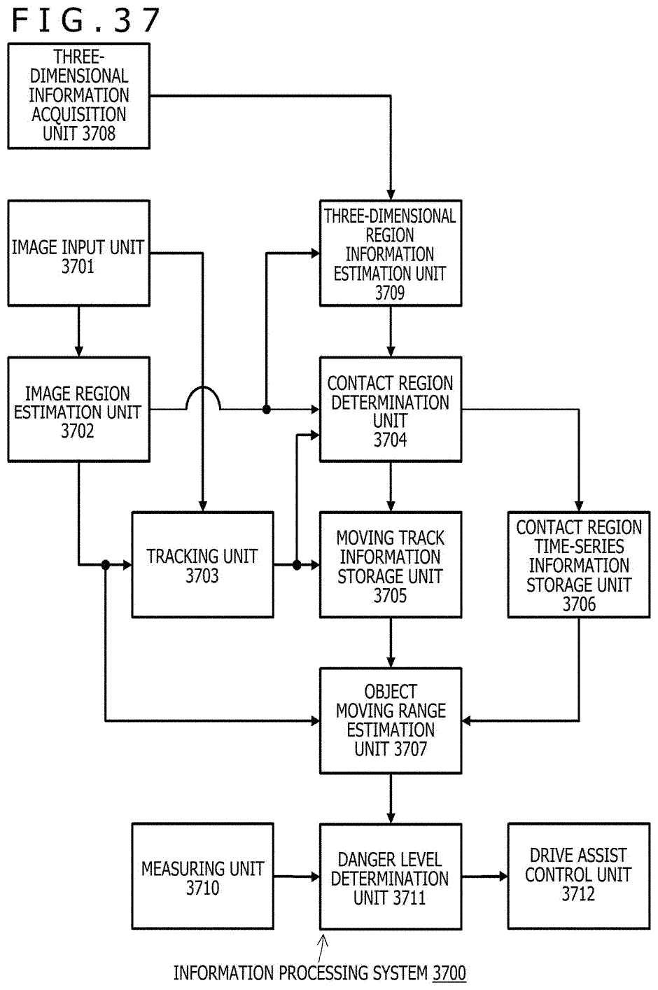

FIG. 37 depicts a functional configuration example of an information processing system 37 according to a fourth embodiment. The information processing system 3700 has a function of estimating a moving range of an object such as a pedestrian and a bicycle on the basis of image information associated with surroundings of the own vehicle and captured by an in-vehicle camera, for example. Drive assistance such as warning to the driver, brake assist operation, or control of automatic operation is achievable on the basis of an estimation result obtained by the information processing system 3700.

The information processing system 3700 depicted in the figure includes an image input unit 3701, an image region estimation unit 3702, a tracking unit 3703, a contact region determination unit 3704, a moving track information storage unit 3705, a contact region time-series information storage unit 3706, an object moving range estimation unit 3707, a three-dimensional shape information acquisition unit 3708, a three-dimensional region information estimation unit 3709, a measuring unit 3710, a danger level determination unit 3711, and a drive assist control unit 3712.

At least some of constituent elements of the information processing system 3700 are implemented using constituent elements included in the vehicle control system 100. Moreover, some of the constituent elements of the information processing system 3700 may also be implemented using an information terminal carried into the vehicle interior by the person on board, such as a smartphone and a tablet, or other information apparatuses. In addition, it is assumed that bidirectional data communication between the respective constituent elements of the information processing system 3700 is achievable via a bus or using interprocess communication. The respective constituent elements included in the information processing system 3700 will be hereinafter described.

The image input unit 3701 inputs image information associated with surroundings of the own vehicle, such as an image captured by an in-vehicle camera. However, it is not required to directly input the image information from an image sensor. Two-dimensional bird's eye view information obtained by conversion into a two-dimensional bird's eye view figure, equivalent and identical map information, or three-dimensional shape information using time-series measurement information and SLAM or SfM may be used.

The image region estimation unit 3702 estimates respective regions in the image input via the image input unit 3701, by using the semantic segmentation technology, and outputs, for each pixel, information to which a label for identifying a category has been added. Objects are extracted on the basis of an estimation result obtained by the image region estimation unit 3702.

The tracking unit 3703 tracks, using the image input via the image input unit 3701, respective objects extracted on the basis of the estimation result obtained by the image region estimation unit 3702.

The three-dimensional shape information acquisition unit 3708 acquires three-dimensional shape information associated with an environment by stereoscopy or using a distance sensor such as a TOF sensor and a LiDAR.

The three-dimensional region information estimation unit 3709 estimates three-dimensional region information on the basis of the estimation result obtained by the image region estimation unit 3702 and the three-dimensional shape information acquired by the three-dimensional shape information acquisition unit 3708.

The contact region determination unit 3704 determines, on the basis of the tracking result of the objects obtained by the tracking unit 3703, a contact region of each of the objects by using the two-dimensional region information estimated by the image region estimation unit 3702, and the three-dimensional region information estimated by the three-dimensional region information estimation unit 3709. For example, it is determined which of a sidewalk, a driveway, and others is a ground contact surface of each of the objects such as a pedestrian and a bicycle.

The moving track information storage unit 3705 stores, for each of the objects, information associated with a moving track of each of the objects and extracted by the tracking unit 3703. Moreover, the contact region time-series information storage unit 3706 stores, for each of the objects, time-series information associated with the contact region of each of the objects and determined by the contact region determination unit 3704.

The object moving range estimation unit 3707 estimates a moving range of each of the objects by using the estimation result obtained by the image region estimation unit 3702 on the basis of the information associated with the contact region of the object and stored in the moving track information storage unit 3705, and the time-series information associated with the contact region of the object and stored in the contact region time-series information storage unit 3706, and outputs the estimated or predicted moving range of each of the objects. In a case where the time-series information associated with the contact region of each of the objects contains speed information associated with the object, the object moving range estimation unit 3707 may estimate the moving range in consideration of the speed information associated with the object as well.

For example, the object moving range estimation unit 3707 estimates the moving range of each of the objects on the basis of rules. Moreover, at the time of estimation of the moving range of the object on the basis of rules, a moving track of the object (speed information based on the moving track) or time-series information associated with the contact region is used as a correction coefficient for linear prediction. Further, the object moving range estimation unit 3707 may estimate the moving range of each of the objects by machine learning. The machine learning uses a neural network. In a case of machine learning of time-series information associated with the contact region or the like, RNN may be used.

The measuring unit 3710 measures a steering angle and a vehicle speed of the own vehicle. The measuring unit 3710 may be the data acquisition unit 102 (described above) in the vehicle control system 100. Alternatively, the measuring unit 3710 may be replaced with a function module which inputs vehicle control information such as a steering angle and a vehicle speed from the vehicle control system 100.

The danger level determination unit 3711 determines, for each of the objects, a danger level of a collision with the own vehicle on the basis of a comparison result between the moving range of each of the objects estimated by the object moving range estimation unit 3707 and the vehicle control information associated with the own vehicle such as a steering angle and a vehicle speed. Specifically, the danger level determination unit 3711 predicts a future reaching range of the own vehicle on the basis of the vehicle control information associated with the own vehicle such as a steering angle and a vehicle speed, and searches for an intersection of the predicted future reaching range and the estimated moving range of each of the objects to determine that there is a danger of a collision between the own vehicle and the object for which an intersection has been found.

The drive assist control unit 3712 assists driving of the own vehicle on the basis of a determination result obtained by the danger level determination unit 3711. The drive assist control unit 3712 may be the emergency avoidance unit 171 (described above) in the vehicle control system 100. The emergency avoidance unit 171 plans an action of the own vehicle for avoiding a collision with the object determined to possibly collide with the own vehicle, and supplies data indicating the planned action of the own vehicle to the acceleration/deceleration control unit 172 and the direction control unit 173 to achieve the damage reduction brake function. Moreover, the vehicle control system 100 may also be configured such that the output control unit 105 gives warning, such as output of audio data containing a warning sound, a warning message, or the like from the output unit 106, as well as the damage reduction brake function.

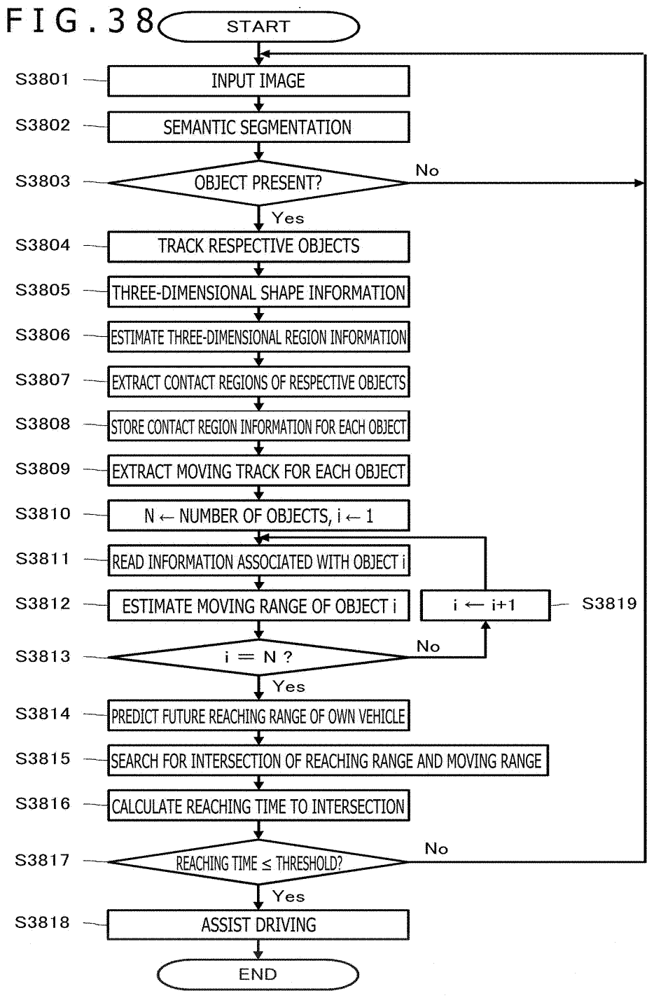

FIG. 38 presents a processing procedure performed by the information processing system 3700 in a form of a flowchart.

Initially, the image input unit 3701 inputs image information associated with surroundings of the own vehicle, such as an image captured by an in-vehicle camera (step S3801).

Subsequently, the image region estimation unit 3702 performs a semantic segmentation process for the input image, and outputs a processing result (step S3802).

Thereafter, the tracking unit 3703 checks whether or not an object is present in a regional image obtained by the semantic segmentation process (step S3803). The object referred to herein is a predicted object which may collide with the own vehicle, such as a pedestrian, a bicycle, and a surrounding vehicle.

In a case where no object has been found (No in step S3803), the process returns to step S3801 and inputs a next image.

On the other hand, in a case where objects have been found (Yes in step S3803), the tracking unit 3703 extracts information associated with the objects from the regional image obtained by the semantic segmentation process, and tracks the respective objects by using the image input in step S3801 (step S3804).

Subsequently, the three-dimensional shape information acquisition unit 3708 acquires three-dimensional shape information associated with an environment by stereoscopy or using a distance sensor such as a TOF sensor and a LiDAR (step S3805).

Thereafter, the three-dimensional region information estimation unit 3709 estimates three-dimensional region information on the basis of the estimation result obtained by the image region estimation unit 3702 and the three-dimensional shape information acquired by the three-dimensional shape information acquisition unit 3708 (step S3806).

Then, the contact region determination unit 3704 extracts information associated with contact regions of the respective objects on the basis of the estimation result obtained by the image region estimation unit 3702, the three-dimensional region information associated with the environment, and the tracking result of the objects obtained by the tracking unit 3703 (step S3807).

Then, the contact region time-series information storage unit 3706 stores, for each of the objects, time-series information associated with the contact region of each of the objects and extracted by the contact region determination unit 3704 (step S3808).

Moreover, the moving track information storage unit 3705 stores, for each of the objects, information associated with a moving track of each of the objects and extracted by the tracking unit 3703 (step S3809).

Subsequently, the total number of the objects found in step S3803 is substituted for a variable N, and an initial value 1 is substituted for a variable i which is a count number of the processed objects (step S3810).

Thereafter, moving history information and contact region time-series information associated with the ith object are read from the moving history information storage unit 3705 and the contact region time-series information storage unit 3706, respectively (step S3811), and a moving range of the ith object is estimated by the object moving range estimation unit 3707 (step S3812).

In a case where i is smaller than N, i.e., unprocessed objects still remain herein (No in step S3813), i is incremented only by 1 (step S3819). Then, the process returns to step S3811 to repeatedly perform an estimation process for estimating a moving range of a next object.

On the other hand, when i reaches N, i.e., in a case where the moving range estimation process has been completed for all of the objects (Yes in step S3813), a danger level determination process is subsequently performed for each of the objects.

Initially, the danger level determination unit 3711 predicts a future reaching range of the own vehicle on the basis of vehicle control information associated with the own vehicle, such as a steering angle and a vehicle speed (step S3814).

Subsequently, the danger level determination unit 3711 searches for an intersection of the predicted future reaching range of the own vehicle and the estimated moving range of each of the objects (step S3815).

Thereafter, in a case where an intersection has been detected, the danger level determination unit 3711 calculates a time required for the own vehicle to reach this intersection (step S3816).

Then, the danger level determination unit 3711 compares a length of the time required for the own vehicle to reach the intersection with a predetermined threshold (step S3817).

In a case where the time required for the own vehicle to reach the intersection is equal to or shorter than the threshold (Yes in step S3817), the danger level determination unit 3711 determines that there is a danger of a collision between the own vehicle and the object. In this case, the drive assist control unit 3712 assists driving of the own vehicle on the basis of a determination result obtained by the danger level determination unit 3711 (step S3818).

The drive assist control unit 3712 plans an action of the own vehicle for avoiding a collision with the object determined to possibly collide with the vehicle, and supplies data indicating the planned action of the own vehicle to the acceleration/deceleration control unit 172 and the direction control unit 173 to achieve the damage reduction brake function. Moreover, the output control unit 105 may output warning, such as output of audio data containing a warning sound, a warning message, or the like, from the output unit 106 as well as the damage reduction brake function.

Further, when the time required for the own vehicle to reach the intersection is longer than the threshold (No in step S3817), the danger level determination unit 3711 determines that there is no danger of a collision between the own vehicle and the object. Then, the process returns to step S3801 to repeatedly execute tracking of objects, estimate moving ranges of objects, and the danger level determination process as described above.

### INDUSTRIAL APPLICABILITY

The technology disclosed in the present description has been described above in detail with reference to the specific embodiments. It is obvious, however, that those skilled in the art can make corrections or substitutions for the embodiments without departing from the subject matters of the technology disclosed in the present description.

While the embodiments associated with prediction of a collision between a vehicle and an object such as a pedestrian have been mainly described in the present description, an application range of the technology disclosed in the present description is not limited to a vehicle. For example, the technology disclosed in the present description is similarly applicable to drive assistance for mobile body devices of various types other than vehicles, such as an unmanned aerial vehicle such as a drone, a robot autonomously moving in a predetermined work space (e.g., home, office, and plant), a vessel, and an aircraft. Needless to say, the technology disclosed in the present description is similarly applicable to various types of information terminals provided on mobile body devices, and various devices of not mobile types.

In short, while the technology disclosed in the present description has been described by presenting examples, it should not be interpreted that the contents presented in the present description are limited to these examples. The claims should be taken into consideration to determine the subject matters of the technology disclosed in the present description.

Note that the technology disclosed in the present description may have following configurations.

(1) An information processing apparatus including:

an input unit that inputs an image;

a region estimation unit that estimates a region of an object contained in the image;

a moving history information acquisition unit that acquires information associated with a moving history of the object;

a contact region determination unit that determines a contact region in contact with the object on the basis of an estimation result obtained by the region estimation unit; and

a moving range estimation unit that estimates a moving range of the object on the basis of the moving history containing the contact region of the object.

(2) The information processing apparatus according to (1) described above, in which the region estimation unit estimates the object on the basis of the image by using semantic segmentation.

(3) The information processing apparatus according to (1) or (2) described above, in which the moving range estimation unit estimates the moving range of the object on the basis of the moving history containing speed information indicating a speed of movement of the object.

(4) The information processing apparatus according to any one of (1) to (3) described above, further including:

a contact region determination unit that determines a contact region in contact with the object on the basis of an estimation result obtained by the region estimation unit; and

a moving track storage unit that stores a moving track obtained by tracking the object, in which

the moving range estimation unit estimates the moving range of the object on the basis of the moving history further containing the moving track of the object.

(5) The information processing apparatus according to (4) described above, in which

the contact region determination unit determines a region in ground contact with the object, and

the moving range estimation unit estimates the moving range of the object on the basis of the moving history containing semantics of the region in ground contact with the object.

(6) The information processing apparatus according to (5) described above, in which the contact region estimation unit estimates semantics of the region in ground contact with the object by using semantic segmentation.

(7) The information processing apparatus according to (5) or (6) described above, further including:

a contact region time-series information storage unit that stores time-series information associated with the contact region determined by the contact region determination unit, in which

the moving range estimation unit estimates the moving range of the object on the basis of the time-series information associated with the contact region.

(8) The information processing apparatus according to (7) described above, further including:

a moving track prediction unit that predicts a future moving track of the object on the basis of moving track information associated with the object; and

a contact region prediction unit that predicts a future contact region of the object on the basis of the moving history of the object, the time-series information associated with the contact region of the object, and prediction of the future moving track, in which

the moving range estimation unit estimates the moving range of the object further on the basis of the predicted future moving track and the predicted future contact region of the object.

(9) The information processing apparatus according to (8) described above, further including:

a target region estimation unit that estimates a target region corresponding to a movement target of the object on the basis of the future moving track of the object predicted by the moving track prediction unit; and

a moving range re-estimation unit that re-estimates the moving range of the object estimated by the multi-moving range estimation unit.

(10) The information processing apparatus according to (9) described above, in which the moving range re-estimation unit redesigns a route allowing the object to avoid an obstacle located on a route reaching the target region, and re-estimates a moving route of the object on the basis of the redesigned route.

(11) The information processing apparatus according to (10) described above, in which,

in a case where plural future moving tracks and contact regions of the object are predicted,

the target region estimation unit estimates a target region for each of prediction results, and

the moving route re-estimation unit redesigns a route reaching the target region while avoiding the obstacle for each of the prediction results, and re-estimates a moving route of the object.

(12) The information processing apparatus according to any one of (4) to (11) described above, further including:

a three-dimensional region information estimation unit that estimates three-dimensional region information associated with the object, in which

the contact region determination unit determines the contact region in contact with the object further on the basis of the three-dimensional region information.

(13) The information processing apparatus according to (12) described above, in which the three-dimensional region information estimation unit estimates the three-dimensional region information on the basis of the estimation result obtained by the region estimation unit.

(14) The information processing apparatus according to (12) or (13) described above, further including:

a three-dimensional shape information acquisition unit that acquires three-dimensional shape information associated with the object, in which

the three-dimensional region information estimation unit estimates the three-dimensional region information further on the basis of the three-dimensional shape information.

(15) The information processing apparatus according to any one of (1) to (14) described above, in which the input unit inputs an image captured by a camera mounted on a mobile body or a camera that images surroundings of the mobile body.

(16) An information processing method including:

an input step of inputting an image;

a region estimation step of estimating a region of an object contained in the image;

a moving history information acquisition step of acquiring information associated with a moving history of the object; and

a moving range estimation step of estimating a moving range of the object on the basis of the moving history.

(17) A computer program written in a computer-readable manner to cause a computer to function as:

an input unit that inputs an image;

a region estimation unit that estimates a region of an object contained in the image;

a moving history information acquisition unit that acquires information associated with a moving history of the object;

a contact region determination unit that determines a contact region in contact with the object on the basis of an estimation result obtained by the region estimation unit; and

a moving range estimation unit that estimates a moving range of the object on the basis of the moving history containing the contact region of the object.

(18) A mobile body device including:

a mobile main body;

a camera mounted on the mobile body or a camera that images surroundings of the mobile body;

a region estimation unit that estimates a region of an object contained in an image captured by the camera;

a moving history information acquisition unit that acquires information associated with a moving history of the object;

a moving range estimation unit that estimates a moving range of the object on the basis of the moving history; and

a control unit that controls driving of the mobile main body on the basis of the moving range of the object.

(19) The mobile body device according to (18) described above, in which the control unit determines a danger level of a collision between the mobile main body and the object on the basis of a result of comparison between a predicted future reaching range of the mobile main body and the moving range of the object.

(20) The mobile body device according to (19) described above, in which the control unit controls driving of the mobile body to avoid the collision.

### REFERENCE SIGNS LIST

100: Vehicle control system
101: Input unit
102: Data acquisition unit
103: Communication unit
104: In-vehicle apparatus
105: Output control unit
106: Output unit
107: Drive control unit
108: Drive system
109: Body control unit
110: Body system
111: Storage unit
112: Autonomous driving control unit
121: Communication network
131: Detection unit
132: Self-position estimation unit
133: Situation analysis unit
134: Planning unit
135: Action control unit
141: Exterior information detection unit
142: Interior information detection unit
143: Vehicle state detection unit
151: Map analysis unit
152: Traffic rule recognition unit
153: Situation recognition unit
154: Situation prediction unit
161: Route planning unit
162: Conduct planning unit
163: Action planning unit
171: Emergency avoidance unit
172: Acceleration/deceleration control unit
173: Direction control unit
200: Information processing system
201: Image input unit
202: Image region estimation unit
203: Tracking unit
204: Contact region determination unit
205: Moving track information storage unit
206: Contact region time-series information storage unit
207: Object moving range estimation unit
208: Measuring unit
209: Danger level determination unit
210: Drive assist control unit
800: Information processing system
801: Image input unit
802: Image region estimation unit
803: Tracking unit
804: Contact region determination unit
805: Moving track information storage unit
806: Contact region time-series information storage unit
807: Object moving range estimation unit
808: Object moving track prediction unit
809: Object contact region prediction unit
810: Measuring unit
811: Danger level determination unit
812: Drive assist control unit
2500: Information processing system
2501: Image input unit
2502: Image region estimation unit
2503: Tracking unit
2504: Contact region determination unit
2505: Moving track information storage unit
2506: Contact region time-series information storage unit
2507: Object moving range estimation unit
2508: Object moving track prediction unit
2509: Object contact region prediction unit
2510: Target region estimation unit
2511: Object moving range re-estimation unit
2512: Measuring unit
2513: Danger level determination unit
2514: Drive assist control unit
3700: Information processing system
3701: Image input unit
3702: Image region estimation unit
3703: Tracking unit
3704: Contact region determination unit
3705: Moving track information storage unit
3706: Contact region time-series information storage unit
3707: Object moving range estimation unit
3708: Three-dimensional shape information acquisition unit
3709: Three-dimensional region information estimation unit
3710: Measuring unit
3711: Danger level determination unit
3712: Drive assist control unit

1. An information processing apparatus comprising:
an input unit that inputs an image;
a region estimation unit that estimates a region of an object contained in the image;
a moving history information acquisition unit that acquires information associated with a moving history of the object;
a contact region determination unit that determines a contact region in contact with the object on a basis of an estimation result obtained by the region estimation unit; and
a moving range estimation unit that estimates a moving range of the object on a basis of the moving history containing the contact region of the object.

2. The information processing apparatus according to claim 1, wherein the region estimation unit estimates the object on a basis of the image by using semantic segmentation.

3. The information processing apparatus according to claim 1, wherein the moving range estimation unit estimates the moving range of the object on a basis of the moving history containing speed information indicating a speed of movement of the object.

4. The information processing apparatus according to claim 1, further comprising:
a moving track storage unit that stores a moving track obtained by tracking the object, wherein
the moving range estimation unit estimates the moving range of the object on a basis of the moving history further containing the moving track of the object.

5. The information processing apparatus according to claim 4, wherein
the contact region determination unit determines a region in ground contact with the object, and
the moving range estimation unit estimates the moving range of the object on a basis of the moving history containing semantics of the region in ground contact with the object.

6. The information processing apparatus according to claim 5, wherein the contact region estimation unit estimates semantics of the region in ground contact with the object by using semantic segmentation.

7. The information processing apparatus according to claim 5, further comprising:
a contact region time-series information storage unit that stores time-series information associated with the contact region determined by the contact region determination unit, wherein
the moving range estimation unit estimates the moving range of the object on a basis of the time-series information associated with the contact region.

8. The information processing apparatus according to claim 7, further comprising:
a moving track prediction unit that predicts a future moving track of the object on a basis of moving track information associated with the object; and
a contact region prediction unit that predicts a future contact region of the object on a basis of the moving history of the object, the time-series information associated with the contact region of the object, and prediction of the future moving track, wherein
the moving range estimation unit estimates the moving range of the object further on a basis of the predicted future moving track and the predicted future contact region of the object.

9. The information processing apparatus according to claim 8, further comprising:
a target region estimation unit that estimates a target region corresponding to a movement target of the object on a basis of the future moving track of the object predicted by the moving track prediction unit; and
a moving range re-estimation unit that re-estimates the moving range of the object estimated by the multi-moving range estimation unit.

10. The information processing apparatus according to claim 9, wherein the moving range re-estimation unit redesigns a route allowing the object to avoid an obstacle located on a route reaching the target region, and re-estimates a moving route of the object on a basis of the redesigned route.

11. The information processing apparatus according to claim 10, wherein,
in a case where plural future moving tracks and contact regions of the object are predicted,
the target region estimation unit estimates a target region for each of prediction results, and
the moving route re-estimation unit redesigns a route reaching the target region while avoiding the obstacle for each of the prediction results, and re-estimates a moving route of the object.

12. The information processing apparatus according to claim 4, further comprising:
a three-dimensional region information estimation unit that estimates three-dimensional region information associated with the object, wherein
the contact region determination unit determines the contact region in contact with the object further on a basis of the three-dimensional region information.

13. The information processing apparatus according to claim 12, wherein the three-dimensional region information estimation unit estimates the three-dimensional region information on a basis of the estimation result obtained by the region estimation unit.

14. The information processing apparatus according to claim 12, further comprising:
a three-dimensional shape information acquisition unit that acquires three-dimensional shape information associated with the object, wherein
the three-dimensional region information estimation unit estimates the three-dimensional region information further on a basis of the three-dimensional shape information.

15. The information processing apparatus according to claim 1, wherein the input unit inputs an image captured by a camera mounted on a mobile body or a camera that images surroundings of the mobile body.

16. An information processing method comprising:
an input step of inputting an image;
a region estimation step of estimating a region of an object contained in the image;
a moving history information acquisition step of acquiring information associated with a moving history of the object; and
a moving range estimation step of estimating a moving range of the object on a basis of the moving history.

17. A computer program written in a computer-readable manner to cause a computer to function as:
an input unit that inputs an image;
a region estimation unit that estimates a region of an object contained in the image;
a moving history information acquisition unit that acquires information associated with a moving history of the object;
a contact region determination unit that determines a contact region in contact with the object on a basis of an estimation result obtained by the region estimation unit; and
a moving range estimation unit that estimates a moving range of the object on a basis of the moving history containing the contact region of the object.

18. A mobile body device comprising:
a mobile main body;
a camera mounted on the mobile body or a camera that images surroundings of the mobile body;
a region estimation unit that estimates a region of an object contained in an image captured by the camera;
a moving history information acquisition unit that acquires information associated with a moving history of the object;
a moving range estimation unit that estimates a moving range of the object on a basis of the moving history; and
a control unit that controls driving of the mobile main body on a basis of the moving range of the object.

19. The mobile body device according to claim 18, wherein the control unit determines a danger level of a collision between the mobile main body and the object on a basis of a result of comparison between a predicted future reaching range of the mobile main body and the moving range of the object.

20. The mobile body device according to claim 19, wherein the control unit controls driving of the mobile body to avoid the collision.
